(19) United States
(12) Patent Application Publication
(10) Pub. No.: US 2018/0176869 A1
(43) Pub. Date: Jun. 21, 2018

(54) POWER CONTROL IN MILLIMETER-WAVE CONNECTION INITIATION

(71) Applicant: Intel Corporation, Santa Clara, CA (US)

(72) Inventors: Ehsan Aryafar, San Jose, CA (US); Sarabjot Singh, Santa Clara, CA (US); Wook Bong Lee, Pleasanton, CA (US); Jing Zhu, Portland, OR (US); Shu-Ping Yeh, Campbell, CA (US); Nageen Himayat, Fremont, CA (US); Shilpa Talwar, Cupertino, CA (US)

(21) Appl. No.: 15/383,305

(22) Filed: Dec. 19, 2016

(51) Int. Cl. H04W 52/24; H04W 74/08; H04W 76/02

(52) U.S. Cl. CPC H04W 52/243; H04W 76/02; H04W 74/0833

(57) ABSTRACT

In a radio access network, user equipment (UE) is to encode signaling for sector-sweep transmission to a base station via a plurality of directional beams in a millimeter-wave radio band over a random-access shared channel during at least one contention period, and determine a transmission power setting for the directional transmission. The transmission power setting is based on a targeted received signal characteristic to be achieved at the base station using a selected beam direction, and the transmission power setting is determined based on transmission parameters of the UE and reception parameters of the base station, and on channel characteristics. The UE is to initiate transmission of the signaling using the transmission power setting for the plurality of directional beams, wherein the signaling is transmitted to be received according to a targeted received signal characteristic to be achieved at the base station.

### TECHNICAL FIELD

Embodiments pertain to wireless communications. Some embodiments relate to wireless networks including 3GPP (Third Generation Partnership Project) networks, 3GPP LTE (Long Term Evolution) networks, 3GPP LTE-A (LTE Advanced) networks, and fifth-generation (5G) networks. Other embodiments relate to Wi-Fi wireless local area networks (WLANs). Further embodiments are more generally applicable outside the purview of LTE and Wi-Fi networks. Aspects of the embodiments are directed to beam forming, sector sweeping, and collision avoidance in radio-access networks.

### BACKGROUND

Mobile data usage continues growing exponentially at a rate of nearly doubling year-after-year, and this trend is expected to continue. Although recent advances in cellular technology have made improvements in the performance and capacity of mobile networks, it is widely thought that such advances will still fall short of accommodating the anticipated demand for mobile data network service.

One approach to increasing mobile network capacity is utilizing higher frequency radio bands. Millimeter-wave communications, for example, use radio frequencies in the range of 30-300 GHz to provide colossal bandwidth by today's standards—on the order of 20 Gb/s, for example. The propagation of millimeter-wave radio signals differs considerably from more familiar radio signals in the 2-5 GHz range. For one, their range is significantly limited by comparison due to attenuation in the atmosphere. In addition, millimeter-wave signals experience reflections, refractions, and scattering due to walls, buildings and other objects to a much greater extent than lower-frequency signals. These physical challenges also present some useful opportunities for communication system designers. For example, the limited range of millimeter-wave transmissions make them suitable for resource-element (time slot and frequency) reuse in high-density deployments in city blocks, office buildings, schools, stadiums, and the like, where there may be a large plurality of user equipment devices. In addition, the potential for precise directionality control provides opportunity to make extensive use of multi-user multiple input/multiple output (MU-MIMO) techniques. Solutions are needed to make practical use of these opportunities in highly-directional wireless networks.

Millimeter-wave access systems use directional beamforming at both the base station and the user equipment in order to achieve a suitable signal quality for establishing a communication link. A sector sweep procedure may be performed at both, the BS and UE to select transmit and receive beam-forming directions. However, certain sector-sweep procedures are not well-optimized for multiple users simultaneously accessing the channel to perform transmit sector sweeping.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the following figures of the accompanying drawings.

FIG. 1 is a functional diagram of a 3GPP network in accordance with some embodiments.

FIG. 2 is a block diagram of a User Equipment (UE) in accordance with some embodiments.

FIG. 3 is a block diagram of an Evolved Node-B (eNB) in accordance with some embodiments.

FIG. 4 illustrates an example processor-based computing platform according to some embodiments.

FIG. 5 illustrates examples of multiple beam transmission in accordance with some embodiments.

FIG. 6 is a diagram illustrating a MIMO transmission scenario utilizing an eNB and a UE, each having multiple antennas according to some embodiments.

FIG. 7 is a diagram illustrating an exemplary communication network scenario in an aspect of this disclosure.

FIG. 8 is a high-level flow diagram illustrating a basic initial-acquisition process by which a UE and an eNB initiate communication according to some embodiments.

FIGS. 9A-9D are a time-domain communications diagrams illustrating a eNB and UE operations of four phases, respectively, of an initial-acquisition protocol according to some embodiments.

FIG. 10 is a flow diagram illustrating operations performed by a UE to apply a power control arrangement according to some example embodiments.

FIG. 11 is a flow diagram illustrating a transmit sector sweep process carried out by an eNB according to some embodiments.

FIG. 12 is a flow diagram illustrating an example process performed by an eNB for providing channel parameters to UEs according to some embodiments.

### DETAILED DESCRIPTION

The following description and the drawings sufficiently illustrate specific embodiments to enable those skilled in the art to practice them. A number of examples are described in the context of 3GPP communication systems and components thereof. It will be understood that principles of the embodiments are applicable in other types of communication systems, such as Wi-Fi or Wi-Max networks, Bluetooth or other personal-area networks (PANs). Zigbee or other home-area networks (HANs), wireless mesh networks, and the like, without limitation, unless expressly limited by a corresponding claim.

Given the benefit of the present disclosure, persons skilled in the relevant technologies will be able to engineer suitable variations to implement principles of the embodiments in other types of communication systems. For example, it will be understood that a base station or e-Node B (eNB) of a 3GPP context is analogous, generally speaking, to a wireless access point (AP) of a WLAN context. Likewise, user equipment (UE) of a 3GPP context is generally analogous to mobile stations (STAs) of WLANs. Various diverse embodiments may incorporate structural, logical, electrical, process, and other differences. Portions and features of some embodiments may be included in, or substituted for, those of other embodiments. Embodiments set forth in the claims encompass all presently-known, and after-arising, equivalents of those claims.

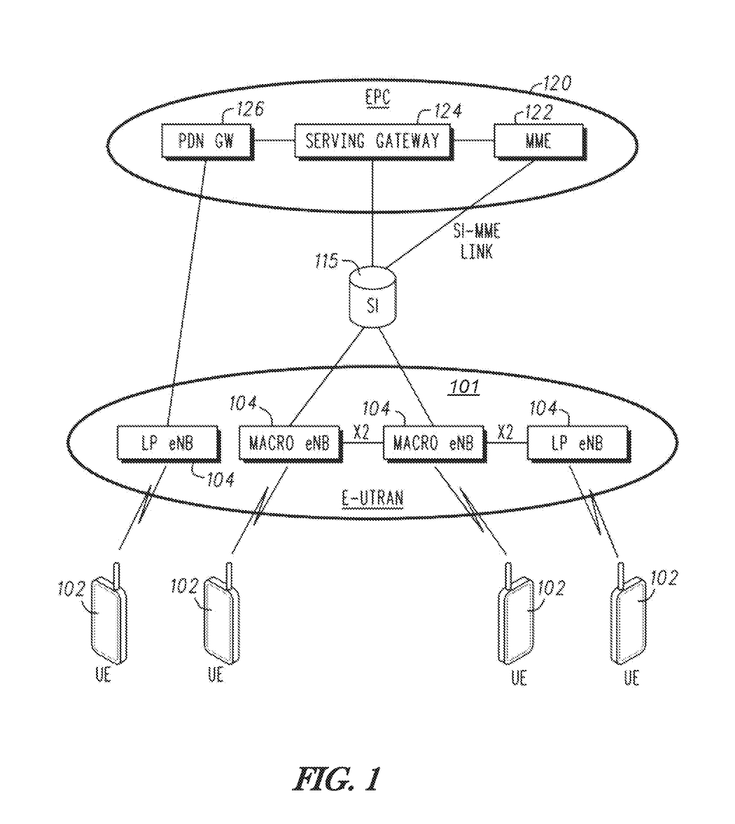

FIG. 1 is a functional diagram of a 3GPP network in accordance with some embodiments. The network comprises a radio access network (RAN) (e.g., as depicted, the E-UTRAN or evolved universal terrestrial radio access network) 101 and the core network 120 (e.g., shown as an evolved packet core (EPC)) coupled together through an S1 interface 115. For convenience and brevity sake, only a portion of the core network 120, as well as the RAN 101, is shown.

The core network 120 includes a mobility management entity (MME) 122, a serving gateway (serving GW) 124, and packet data network gateway (PDN GW) 126. The RAN 101 includes Evolved Node-B's (eNB) 104 (which may operate as base stations) for communicating with User Equipment (UE) 102. Hereinafter, the terms eNB and base station (BS) may be used interchangeably unless a specific distinction is intended, in which case the distinction will be specifically pointed out. The eNBs 104 may include macro eNBs and low power (LP) eNBs. In accordance with some embodiments, the eNB 104 may transmit a downlink control message to the UE 102 to indicate an allocation of physical uplink control channel (PUCCH) channel resources. The UE 102 may receive the downlink control message from the eNB 104, and may transmit an uplink control message to the eNB 104 in at least a portion of the PUCCH channel resources. These embodiments will be described in more detail below.

The MME 122 is similar in function to the control plane of legacy Serving GPRS Support Nodes (SGSN). The MME 122 manages mobility aspects in access such as gateway selection and tracking area list management. The serving GW 124 terminates the interface toward the RAN 101, and routes data packets between the RAN 101 and the core network 120. In addition, it may be a local mobility anchor point for inter-eNB handoffs and also may provide an anchor for inter-3GPP mobility. Other responsibilities may include lawful intercept, charging, and some policy enforcement. The serving GW 124 and the MME 122 may be implemented in one physical node or separate physical nodes. The PDN GW 126 terminates a SGi interface toward the packet data network (PDN). The PDN GW 126 routes data packets between the EPC 120 and the external PDN, and may be a key node for policy enforcement and charging data collection. It may also provide an anchor point for mobility with non-LTE accesses. The external PDN can be any kind of IP network, as well as an IP Multimedia Subsystem (IMS) domain. The PDN GW 126 and the serving GW 124 may be implemented in one physical node or separated physical nodes.

The eNB 104 (macro and micro) terminate the air interface protocol and may be the first point of contact for a UE 102. In some embodiments, an eNB 104 may fulfill various logical functions for the RAN 101 including but not limited to RNC (radio network controller functions) such as radio bearer management, uplink and downlink dynamic radio resource management and data packet scheduling, and mobility management. In accordance with embodiments. UE 102 may be configured to communicate with an eNB 104 over a multipath fading channel in accordance with an Orthogonal Frequency Division Multiple Access (OFDMA) communication technique. The OFDM signals may comprise a plurality of orthogonal subcarriers.

The S1 interface 115 is the interface that separates the RAN 101 and the EPC 120. It is split into two parts: the S1-U, which carries traffic data between the eNB 104 and the serving GW 124, and the S1-MME, which is a signaling interface between the eNB 104 and the MME 122. The X2 interface is the interface between eNB 104. The X2 interface comprises two parts, the X2-C and X2-U. The X2-C is the control plane interface between the eNB 104, while the X2-U is the user plane interface between the eNB 104.

With cellular networks, LP cells are typically used to extend coverage to indoor areas where outdoor signals do not reach well, or to add network capacity in areas with very dense phone usage, such as train stations. As used herein, the term low power (LP) eNB refers to any suitable relatively low power eNB for implementing a narrower cell (narrower than a macro cell) such as a femtocell, a picocell, or a micro cell. Femtocell eNBs are typically provided by a mobile network operator to its residential or enterprise customers. A femtocell is typically the size of a residential gateway or smaller and generally connects to the user's broadband line. Once plugged in, the femtocell connects to the mobile operator's mobile network and provides extra coverage in a range of typically 30 to 50 meters for residential femtocells. Thus, a LP eNB might be a femtocell eNB since it is coupled through the PDN GW 126. Similarly, a picocell is a wireless communication system typically covering a small area, such as in-building (offices, shopping malls, train stations, etc.), or more recently in-aircraft. A picocell eNB can generally connect through the X2 link to another eNB such as a macro eNB through its base station controller (BSC) functionality. Thus, LP eNB may be implemented with a picocell eNB since it is coupled to a macro eNB via an X2 interface. Picocell eNBs or other LP eNBs may incorporate some or all functionality of a macro eNB. In some cases, this may be referred to as an access point base station or enterprise femtocell.

In some embodiments, a downlink resource grid may be used for downlink transmissions from an eNB 104 to a UE 102, while uplink transmission from the UE 102 to the eNB 104 may utilize similar techniques. The grid may be a time-frequency grid, called a resource grid or time-frequency resource grid, which is the physical resource in the downlink in each slot. Such a time-frequency plane representation is a common practice for OFDM systems, which makes it intuitive for radio resource allocation. Each column and each row of the resource grid correspond to one OFDM symbol and one OFDM subcarrier, respectively. The duration of the resource grid in the time domain corresponds to one slot in a radio frame. The smallest time-frequency unit in a resource grid is denoted as a resource element (RE). Each resource grid comprises a number of resource blocks (RBs), which describe the mapping of certain physical channels to resource elements. Each resource block comprises a collection of resource elements in the frequency domain and may represent the smallest quanta of resources that currently can be allocated. There are several different physical downlink channels that are conveyed using such resource blocks. With particular relevance to this disclosure, two of these physical downlink channels are the physical downlink shared channel and the physical down link control channel.

The physical downlink shared channel (PDSCH) carries user data and higher-layer signaling to a UE 102 (FIG. 1). The physical downlink control channel (PDCCH) carries information about the transport format and resource allocations related to the PDSCH channel, among other things. It also informs the UE 102 about the transport format, resource allocation, and hybrid automatic repeat request (HARQ) information related to the uplink shared channel. Typically, downlink scheduling (e.g., assigning control and shared channel resource blocks to UE 102 within a cell) may be performed at the eNB 104 based on channel quality information fed back from the UE 102 to the eNB 104, and then the downlink resource assignment information may be sent to the UE 102 on the control channel (PDCCH) used for (assigned to) the UE 102.

The PDCCH uses CCEs (control channel elements) to convey the control information. Before being mapped to resource elements, the PDCCH complex-valued symbols are first organized into quadruplets, which are then permuted using a sub-block inter-leaver for rate matching. Each PDCCH is transmitted using one or more of these control channel elements (CCEs), where each CCE corresponds to nine sets of four physical resource elements known as resource element groups (REGs).

Four QPSK symbols are mapped to each REG. The PDCCH can be transmitted using one or more CCEs, depending on the size of downlink control information (DCI) and the channel condition. There may be four or more different PDCCH formats defined in LTE with different numbers of CCEs (e.g., aggregation level. L=1, 2, 4, or 8).

As used herein, the term circuitry may refer to, be part of, or include an Application Specific Integrated Circuit (ASIC), an electronic circuit, a processor (shared, dedicated, or group), or memory (shared, dedicated, or group) that executes one or more software or firmware programs, a combinational logic circuit, or other suitable hardware components that provide the described functionality. In some embodiments, the circuitry may be implemented in, or functions associated with the circuitry may be implemented by, one or more software or firmware modules. In some embodiments, circuitry may include logic, at least partially operable in hardware. Embodiments described herein may be implemented into a system using any suitably configured hardware or software.

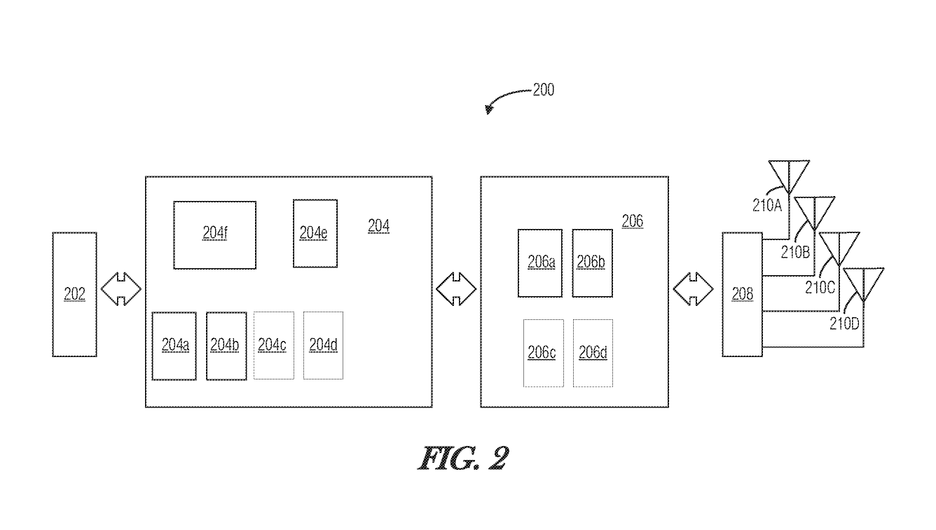

FIG. 2 is a functional diagram of a User Equipment (UE) in accordance with some embodiments. The UE 200 may be suitable for use as a UE 102 as depicted in FIG. 1. In some embodiments, the UE 200 may include application circuitry 202, baseband circuitry 204, Radio Frequency (RF) circuitry 206, front-end module (FEM) circuitry 208 and multiple antennas 210A-210D, coupled together at least as shown. In some embodiments, other circuitry or arrangements may include one or more elements or components of the application circuitry 202, the baseband circuitry 204, the RF circuitry 206 or the FEM circuitry 208, and may also include other elements or components in some cases. As an example, “processing circuitry” may include one or more elements or components, some or all of which may be included in the application circuitry 202 or the baseband circuitry 204. As another example, “transceiver circuitry” may include one or more elements or components, some or all of which may be included in the RF circuitry 206 or the FEM circuitry 208. These examples are not limiting, however, as the processing circuitry or the transceiver circuitry may also include other elements or components in some cases.

The application circuitry 202 may include one or more application processors. For example, the application circuitry 202 may include circuitry such as, but not limited to, one or more single-core or multi-core processors. The processor(s) may include any combination of general-purpose processors and dedicated processors (e.g., graphics processors, application processors, etc.). The processors may be coupled with or may include memory/storage and may be configured to execute instructions stored in the memory/storage to enable various applications or operating systems to run on the system.

The baseband circuitry 204 may include circuitry such as, but not limited to, one or more single-core or multi-core processors. The baseband circuitry 204 may include one or more baseband processors or control logic to process baseband signals received from a receive signal path of the RF circuitry 206 and to generate baseband signals for a transmit signal path of the RF circuitry 206. Baseband processing circuitry 204 may interface with the application circuitry 202 for generation and processing of the baseband signals and for controlling operations of the RF circuitry 206. For example, in some embodiments, the baseband circuitry 204 may include a second generation (2G) baseband processor 204a, third generation (3G) baseband processor 204b, fourth generation (4G) baseband processor 204c, or other baseband processor(s) 204d for other existing generations, generations in development or to be developed in the future (e.g., fifth generation (5G), 6G, etc.). The baseband circuitry 204 (e.g., one or more of baseband processors 204a-d) may handle various radio control functions that enable communication with one or more radio networks via the RF circuitry 206. The radio control functions may include, but are not limited to, signal modulation/demodulation, encoding/decoding, radio frequency shifting, etc. In some embodiments, modulation/demodulation circuitry of the baseband circuitry 204 may include Fast-Fourier Transform (FFT), precoding, or constellation mapping/demapping functionality. In some embodiments, encoding/decoding circuitry of the baseband circuitry 204 may include Low Density Parity Check (LDPC) encoder/decoder functionality, optionally along-side other techniques such as, for example, block codes, convolutional codes, turbo codes, or the like, which may be used to support legacy protocols. Embodiments of modulation/demodulation and encoder/decoder functionality are not limited to these examples and may include other suitable functionality in other embodiments.

In some embodiments, the baseband circuitry 204 may include elements of a protocol stack such as, for example, elements of an evolved universal terrestrial radio access network (EUTRAN) protocol including, for example, physical (PHY), media access control (MAC), radio link control (RLC), packet data convergence protocol (PDCP), or radio resource control (RRC) elements. A central processing unit (CPU) 204e of the baseband circuitry 204 may be configured to run elements of the protocol stack for signaling of the PHY, MAC, RLC, PDCP or RRC layers. In some embodiments, the baseband circuitry may include one or more audio digital signal processor(s) (DSP) 204f. The audio DSP(s) 204f may be include elements for compression/decompression and echo cancellation and may include other suitable processing elements in other embodiments. Components of the baseband circuitry may be suitably combined in a single chip, a single chipset, or disposed on a same circuit board in some embodiments. In some embodiments, some or all of the constituent components of the baseband circuitry 204 and the application circuitry 202 may be implemented together such as, for example, on a system on chip (SOC).

In some embodiments, the baseband circuitry 204 may provide for communication compatible with one or more radio technologies. For example, in some embodiments, the baseband circuitry 204 may support communication with an evolved universal terrestrial radio access network (EUTRAN) or other wireless metropolitan area networks (WMAN), a wireless local area network (WLAN), a wireless personal area network (WPAN). Embodiments in which the baseband circuitry 204 is configured to support radio communications of more than one wireless protocol may be referred to as multi-mode baseband circuitry.

RF circuitry 206 may enable communication with wireless networks using modulated electromagnetic radiation through a non-solid medium. In various embodiments, the RF circuitry 206 may include switches, filters, amplifiers, etc. to facilitate the communication with the wireless network. RF circuitry 206 may include a receive signal path which may include circuitry to down-convert RF signals received from the FEM circuitry 208 and provide baseband signals to the baseband circuitry 204. RF circuitry 206 may also include a transmit signal path which may include circuitry to up-convert baseband signals provided by the baseband circuitry 204 and provide RF output signals to the FEM circuitry 208 for transmission.

In some embodiments, the RF circuitry 206 may include a receive signal path and a transmit signal path. The receive signal path of the RF circuitry 206 may include mixer circuitry 206a, amplifier circuitry 206b and filter circuitry 206c. The transmit signal path of the RF circuitry 206 may include filter circuitry 206c and mixer circuitry 206a. RF circuitry 206 may also include synthesizer circuitry 206d for synthesizing a frequency for use by the mixer circuitry 206a of the receive signal path and the transmit signal path. In some embodiments, the mixer circuitry 206a of the receive signal path may be configured to down-convert RF signals received from the FEM circuitry 208 based on the synthesized frequency provided by synthesizer circuitry 206d. The amplifier circuitry 206b may be configured to amplify the down-converted signals and the filter circuitry 206c may be a low-pass filter (LPF) or band-pass filter (BPF) configured to remove unwanted signals from the down-converted signals to generate output baseband signals. Output baseband signals may be provided to the baseband circuitry 204 for further processing. In some embodiments, the output baseband signals may be zero-frequency baseband signals, although this is not a requirement. In some embodiments, mixer circuitry 206a of the receive signal path may comprise passive mixers, although the scope of the embodiments is not limited in this respect. In some embodiments, the mixer circuitry 206a of the transmit signal path may be configured to up-convert input baseband signals based on the synthesized frequency provided by the synthesizer circuitry 206d to generate RF output signals for the FEM circuitry 208. The baseband signals may be provided by the baseband circuitry 204 and may be filtered by filter circuitry 206c. The filter circuitry 206c may include a low-pass filter (LPF), although the scope of the embodiments is not limited in this respect.

In some embodiments, the mixer circuitry 206a of the receive signal path and the mixer circuitry 206a of the transmit signal path may include two or more mixers and may be arranged for quadrature downconversion or upconversion respectively. In some embodiments, the mixer circuitry 206a of the receive signal path and the mixer circuitry 206a of the transmit signal path may include two or more mixers and may be arranged for image rejection (e.g., Hartley image rejection). In some embodiments, the mixer circuitry 206a of the receive signal path and the mixer circuitry 206a may be arranged for direct downconversion or direct upconversion, respectively. In some embodiments, the mixer circuitry 206a of the receive signal path and the mixer circuitry 206a of the transmit signal path may be configured for super-heterodyne operation.

In some embodiments, the output baseband signals and the input baseband signals may be analog baseband signals, although the scope of the embodiments is not limited in this respect. In some alternate embodiments, the output baseband signals and the input baseband signals may be digital baseband signals. In these alternate embodiments, the RF circuitry 206 may include analog-to-digital converter (ADC) and digital-to-analog converter (DAC) circuitry and the baseband circuitry 204 may include a digital baseband interface to communicate with the RF circuitry 206. In some dual-mode embodiments, a separate radio IC circuitry may be provided for processing signals for each spectrum, although the scope of the embodiments is not limited in this respect.

In some embodiments, the synthesizer circuitry 206d may be a fractional-N synthesizer or a fractional N/N+1 synthesizer, although the scope of the embodiments is not limited in this respect as other types of frequency synthesizers may be suitable. For example, synthesizer circuitry 206d may be a delta-sigma synthesizer, a frequency multiplier, or a synthesizer comprising a phase-locked loop with a frequency divider. The synthesizer circuitry 206d may be configured to synthesize an output frequency for use by the mixer circuitry 206a of the RF circuitry 206 based on a frequency input and a divider control input. In some embodiments, the synthesizer circuitry 206d may be a fractional N/N+1 synthesizer. In some embodiments, frequency input may be provided by a voltage controlled oscillator (VCO), although that is not a requirement. Divider control input may be provided by either the baseband circuitry 204 or the applications processor 202 depending on the desired output frequency. In some embodiments, a divider control input (e.g., N) may be determined from a look-up table based on a channel indicated by the applications processor 202.

Synthesizer circuitry 206d of the RF circuitry 206 may include a divider, a delay-locked loop (DLL), a multiplexer and a phase accumulator. In some embodiments, the divider may be a dual modulus divider (DMD) and the phase accumulator may be a digital phase accumulator (DPA). In some embodiments, the DMD may be configured to divide the input signal by either N or N+1 (e.g., based on a carry out) to provide a fractional division ratio. In some example embodiments, the DLL may include a set of cascaded, tunable, delay elements, a phase detector, a charge pump and a D-type flip-flop. In these embodiments, the delay elements may be configured to break a VCO period up into Nd equal packets of phase, where Nd is the number of delay elements in the delay line. In this way, the DLL provides negative feedback to help ensure that the total delay through the delay line is one VCO cycle.

In some embodiments, synthesizer circuitry 206d may be configured to generate a carrier frequency as the output frequency, while in other embodiments, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some embodiments, the output frequency may be a LO frequency (f_{LO}). In some embodiments, the RF circuitry 206 may include an IQ/polar converter.

FEM circuitry 208 may include a receive signal path which may include circuitry configured to operate on RF signals received from one or more of the antennas 210A-D, amplify the received signals and provide the amplified versions of the received signals to the RF circuitry 206 for further processing. FEM circuitry 208 may also include a transmit signal path which may include circuitry configured to amplify signals for transmission provided by the RF circuitry 206 for transmission by one or more of the one or more antennas 210A-D.

In some embodiments, the FEM circuitry 208 may include a TX/RX switch to switch between transmit mode and receive mode operation. The FEM circuitry may include a receive signal path and a transmit signal path. The receive signal path of the FEM circuitry may include a low-noise amplifier (LNA) to amplify received RF signals and provide the amplified received RF signals as an output (e.g., to the RF circuitry 206). The transmit signal path of the FEM circuitry 208 may include a power amplifier (PA) to amplify input RF signals (e.g., provided by RF circuitry 206), and one or more filters to generate RF signals for subsequent transmission (e.g., by one or more of the one or more antennas 210. In some embodiments, the UE 200 may include additional elements such as, for example, memory/storage, display, camera, sensor, or input/output (I/O) interface.

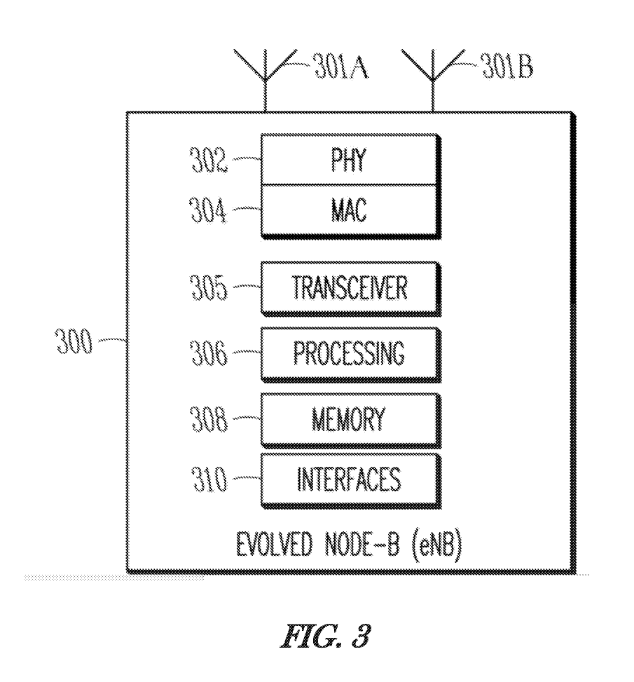

FIG. 3 is a functional diagram of an Evolved Node-B (eNB) in accordance with some embodiments. It should be noted that in some embodiments, the eNB 300 may be a stationary non-mobile device. The eNB 300 may be suitable for use as an eNB 104 as depicted in FIG. 1. The components of eNB 300 may be included in a single device or a plurality of devices. The eNB 300 may include physical layer circuitry 302 and a transceiver 305, one or both of which may enable transmission and reception of signals to and from the UE 200, other eNBs, other UEs or other devices using one or more antennas 301A-B. As an example, the physical layer circuitry 302 may perform various encoding and decoding functions that may include formation of baseband signals for transmission and decoding of received signals. For example, physical layer circuitry 302 may include LDPC encoder/decoder functionality, optionally along-side other techniques such as, for example, block codes, convolutional codes, turbo codes, or the like, which may be used to support legacy protocols. Embodiments of modulation/demodulation and encoder/decoder functionality are not limited to these examples and may include other suitable functionality in other embodiments. As another example, the transceiver 305 may perform various transmission and reception functions such as conversion of signals between a baseband range and a Radio Frequency (RF) range. Accordingly, the physical layer circuitry 302 and the transceiver 305 may be separate components or may be part of a combined component. In addition, some of the described functionality related to transmission and reception of signals may be performed by a combination that may include one, any or all of the physical layer circuitry 302, the transceiver 305, and other components or layers. The eNB 300 may also include medium access control layer (MAC) circuitry 304 for controlling access to the wireless medium. The eNB 300 may also include processing circuitry 306 and memory 308 arranged to perform the operations described herein. The eNB 300 may also include one or more interfaces 310, which may enable communication with other components, including other eNB 104 (FIG. 1), components in the EPC 120 (FIG. 1) or other network components. In addition, the interfaces 310 may enable communication with other components that may not be shown in FIG. 1, including components external to the network. The interfaces 310 may be wired or wireless or a combination thereof.

The antennas 210A-D, 301A-B may comprise one or more directional or omnidirectional antennas, including, for example, phased-array antennas, dipole antennas, monopole antennas, patch antennas, loop antennas, microstrip antennas or other types of antennas suitable for transmission of RF signals. In some multiple-input multiple-output (MIMO) embodiments, the antennas 210A-D, 301A-B may be effectively separated to take advantage of spatial diversity and the different channel characteristics that may result.

In some embodiments, the UE 200 or the eNB 300 may be a mobile device and may be a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a wearable device such as a medical device (e.g., a heart rate monitor, a blood pressure monitor, etc.), or other device that may receive or transmit information wirelessly. In some embodiments, the UE 200 or eNB 300 may be configured to operate in accordance with 3GPP standards, although the scope of the embodiments is not limited in this respect. Mobile devices or other devices in some embodiments may be configured to operate according to other protocols or standards, including IEEE 802.11 (e.g., 802.11ac, 802.11ad, 802.11ax, 802.11ay) or other IEEE standards. In some embodiments, the UE 200, eNB 300 or other device may include one or more of a keyboard, a display, a non-volatile memory port, multiple antennas, a graphics processor, an application processor, speakers, and other mobile device elements. The display may be an LCD screen including a touch screen.

Although the UE 200 and the eNB 300 are each illustrated as having several separate functional elements, one or more of the functional elements may be combined and may be implemented by combinations of software-configured elements, such as processing elements including digital signal processors (DSPs), or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

Embodiments may be implemented in one or a combination of hardware, firmware and software. Embodiments may also be implemented as instructions stored on a computer-readable storage device, which may be read and executed by at least one processor to perform the operations described herein. A computer-readable storage device may include any non-transitory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. Some embodiments may include one or more processors and may be configured with instructions stored on a computer-readable storage device.

It should be noted that in some embodiments, an apparatus used by the UE 200 or eNB 300 may include various components of the UE 200 or the eNB 300 as shown in FIGS. 2-3. Accordingly, techniques and operations described herein that refer to the UE 200 (or 102) may be applicable to an apparatus for a UE. In addition, techniques and operations described herein that refer to the eNB 300 (or 104) may be applicable to an apparatus for an eNB.

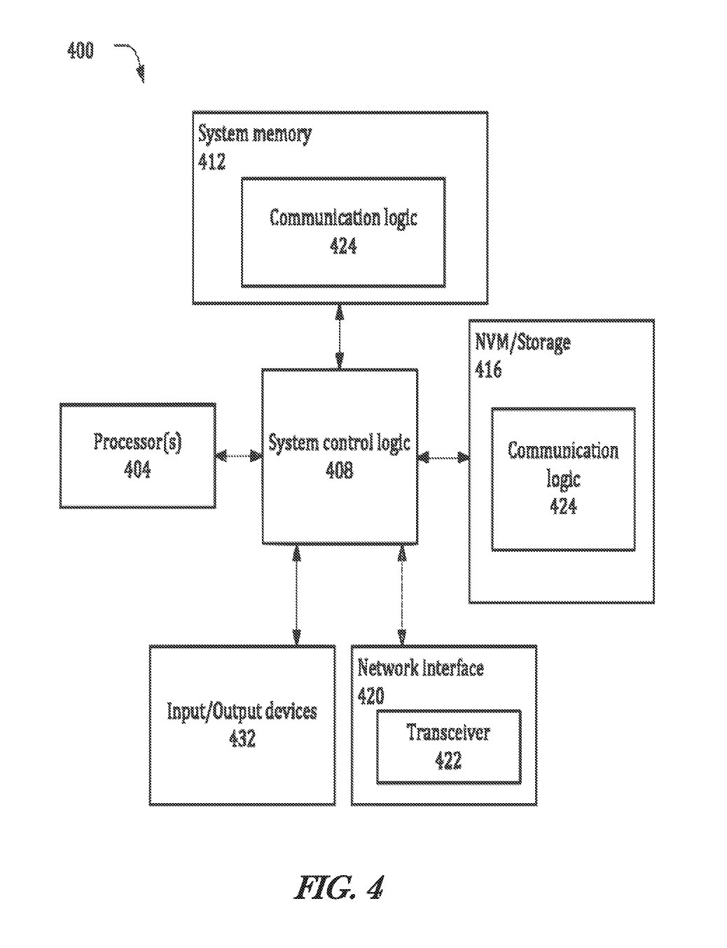

FIG. 4 illustrates an example processor-based computing platform according to some embodiments. As depicted, system 400 includes one or more processor(s) 404, system control logic 408 coupled with at least one of the processor(s) 404, system memory 412 coupled with system control logic 408, non-volatile memory (NVM)/storage 416 coupled with system control logic 408, a network interface 420 coupled with system control logic 408, and input/output (I/O) devices 432 coupled with system control logic 408.

The processor(s) 404 may include one or more single-core or multi-core processors. The processor(s) 404 may include any combination of general-purpose processors and dedicated processors (e.g., graphics processors, application processors, baseband processors, etc.).

System control logic 408 for some embodiments may include any suitable interface controllers to provide for any suitable interface to at least one of the processor(s) 404 and/or to any suitable device or component in communication with system control logic 408.

System control logic 408 for some embodiments may include one or more memory controller(s) to provide an interface to system memory 412. System memory 412 may be used to load and store data and/or instructions, e.g., communication logic 424. System memory 412 for some embodiments may include any suitable volatile memory, such as suitable dynamic random access memory (DRAM), for example.

NVM/storage 416 may include one or more tangible, non-transitory computer-readable media used to store data and/or instructions, e.g., communication logic 424. NVM/storage 416 may include any suitable non-volatile memory, such as flash memory, for example, and/or may include any suitable non-volatile storage device(s), such as one or more hard disk drive(s) (HDD(s)), one or more compact disk (CD) drive(s), and/or one or more digital versatile disk (DVD) drive(s), for example.

The NVM/storage 416 may include a storage resource physically part of a device on which the system 400 is installed or it may be accessible by, but not necessarily a part of, the device. For example, the NVM/storage 416 may be accessed over a network via the network interface 420 and/or over Input/Output (I/O) devices 432.

The communication logic 424 may include instructions that, when executed by one or more of the processors 404, cause the system 400 to perform operations associated with the components of the communication device IRP manager 128, IRP agent 132, mapping circuitry 136 and/or the methods 200 or 300 as described with respect to the above embodiments. In various embodiments, the communication logic 424 may include hardware, software, and/or firmware components that may or may not be explicitly shown in system 400.

Network interface 420 may have a transceiver 422 to provide a radio interface for system 400 to communicate over one or more network(s) and/or with any other suitable device. In various embodiments, the transceiver 422 may be integrated with other components of system 400. For example, the transceiver 422 may include a processor of the processor(s) 404, memory of the system memory 412, and NVM/Storage of NVM/Storage 416. Network interface 420 may include any suitable hardware and/or firmware. Network interface 420 may include a plurality of antennas to provide a multiple input, multiple output radio interface. Network interface 420 for some embodiments may include, for example, a wired network adapter, a wireless network adapter, a telephone modem, and/or a wireless modem.

For some embodiments, at least one of the processor(s) 404 may be packaged together with logic for one or more controller(s) of system control logic 408. For some embodiments, at least one of the processor(s) 404 may be packaged together with logic for one or more controllers of system control logic 408 to form a System in Package (SiP). For some embodiments, at least one of the processor(s) 404 may be integrated on the same die with logic for one or more controller(s) of system control logic 408. For some embodiments, at least one of the processor(s) 404 may be integrated on the same die with logic for one or more controller(s) of system control logic 408 to form a System on Chip (SoC).

In various embodiments, the I/O devices 432 may include user interfaces designed to enable user interaction with the system 400, peripheral component interfaces designed to enable peripheral component interaction with the system 400, and/or sensors designed to determine environmental conditions and/or location information related to the system 400.

In various embodiments, the user interfaces could include, but are not limited to, a display (e.g., a liquid crystal display, a touch screen display, etc.), speakers, a microphone, one or more cameras (e.g., a still camera and/or a video camera), a flashlight (e.g., a light emitting diode flash), and a keyboard.

In various embodiments, the peripheral component interfaces may include, but are not limited to, a non-volatile memory port, a universal serial bus (USB) port, an audio jack, an Ethernet connection, and a power supply interface.

In various embodiments, the sensors may include, but are not limited to, a gyro sensor, an accelerometer, a proximity sensor, an ambient light sensor, and a positioning unit. The positioning unit may also be part of, or interact with, the network interface 420 to communicate with components of a positioning network, e.g., a global positioning system (GPS) satellite.

In various embodiments, the system 400 may be implemented on a server, or system of networked server machines. System 400 may also be virtualized in some embodiments on a host machine or on a set of host machines operating using distributed computing techniques. In other embodiments, system 400 may be implemented on one or more mobile computing devices such as, but not limited to, a laptop computing device, a tablet computing device, a netbook, a smartphone, etc. In various embodiments, system 400 may have more or less components, and/or different architectures.

Examples, as described herein, may include, or may operate on, logic or a number of components, engines, modules, or circuitry which for the sake of consistency are termed engines, although it will be understood that these terms may be used interchangeably. Engines may be hardware, software, or firmware communicatively coupled to one or more processors in order to carry out the operations described herein. Engines may be hardware engines, and as such engines may be considered tangible entities capable of performing specified operations and may be configured or arranged in a certain manner. In an example, circuits may be arranged (e.g., internally or with respect to external entities such as other circuits) in a specified manner as an engine. In an example, the whole or part of one or more hardware processors may be configured by firmware or software (e.g., instructions, an application portion, or an application) as an engine that operates to perform specified operations. In an example, the software may reside on a machine-readable medium. In an example, the software, when executed by the underlying hardware of the engine, causes the hardware to perform the specified operations. Accordingly, the term hardware engine is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein.

Considering examples in which engines are temporarily configured, each of the engines need not be instantiated at any one moment in time. For example, where the engines comprise a general-purpose hardware processor core configured using software; the general-purpose hardware processor core may be configured as respective different engines at different times. Software may accordingly configure a hardware processor core, for example, to constitute a particular engine at one instance of time and to constitute a different engine at a different instance of time.

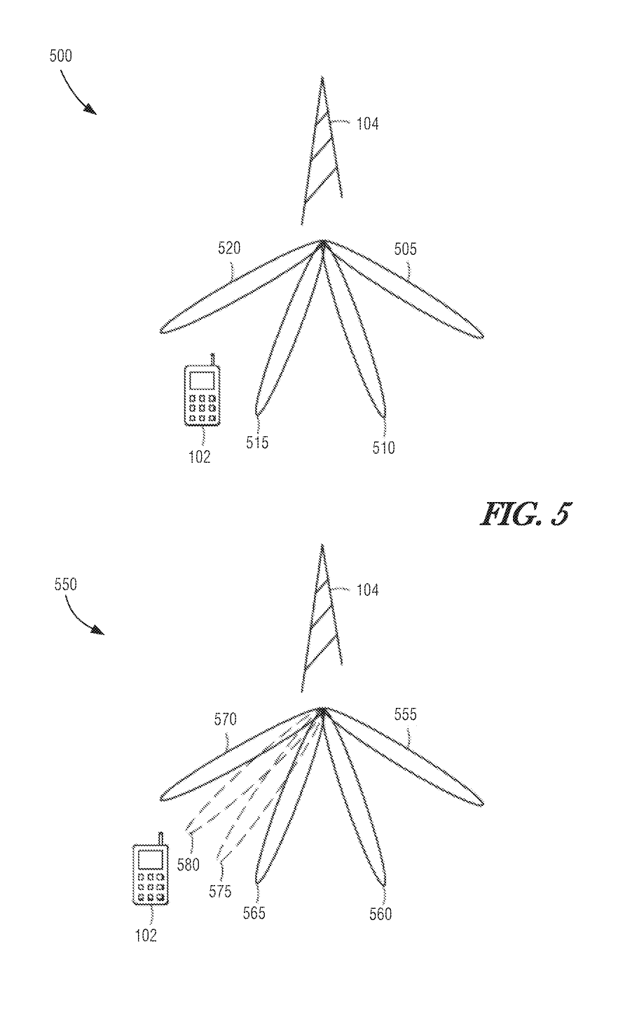

FIG. 5 illustrates examples of multiple beam transmission in accordance with some embodiments. Although the example scenarios 500 and 550 depicted in FIG. 5 may illustrate some aspects of techniques disclosed herein, it will be understood that embodiments are not limited by example scenarios 500 and 550. Embodiments are not limited to the number or type of components shown in FIG. 5 and are also not limited to the number or arrangement of transmitted beams shown in FIG. 5.

In example scenario 500, the eNB 104 may transmit a signal on multiple beams 505-520, any or all of which may be received at the UE 102. It should be noted that the number of beams or transmission angles as shown are not limiting. As the beams 505-520 may be directional, transmitted energy from the beams 505-520 may be concentrated in the direction shown. Therefore, the UE 102 may not necessarily receive a significant amount of energy from beams 505 and 510 in some cases, due to the relative location of the UE 102.

UE 102 may receive a significant amount of energy from the beams 515 and 520 as shown. As an example, the beams 505-520 may be transmitted using different reference signals, and the UE 102 may determine channel-state information (CSI) feedback or other information for beams 515 and 520. In some embodiments, each of beams 505-520 are configured as CSI reference signals (CSI-RS). In related embodiments, the CSI-RS signal is a part of the discovery reference signaling (DRS) configuration. The DRS configuration may serve to inform the UE 102 about the physical resources (e.g., subframes, subcarriers) on which the CSI-RS signal will be found. In related embodiments, the UE 102 is further informed about any scrambling sequences that are to be applied for CSI-RS.

In some embodiments, up to 2 MIMO layers may be transmitted within each beam by using different polarizations. More than 2 MIMO layers may be transmitted by using multiple beams. In related embodiments, the UE is configured to discover the available beams and report those discovered beams to the eNB prior to the MIMO data transmissions using suitable reporting messaging, such as channel-state reports (CSR), for example. Based on the reporting messaging, the eNB 104 may determine suitable beam directions for the MIMO layers to be used for data communications with the UE 102. In various embodiments, there may be up to 2, 4, 8, 16, 32, or more MIMO layers, depending on the number of MIMO layers that are supported by the eNB 104 and UE 102. In a given scenario, the number of MIMO layers that may actually be used will depend on the quality of the signaling received at the UE 102, and the availability of reflected beams arriving at diverse angles at the UE 102 such that the UE 102 may discriminate the data carried on the separate beams.

In the example scenario 550, the UE 102 may determine angles or other information (such as CSI feedback, channel-quality indicator (CQI) or other) for the beams 565 and 570. The UE 102 may also determine such information when received at other angles, such as the illustrated beams 575 and 580. The beams 575 and 580 are demarcated using a dotted line configuration to indicate that they may not necessarily be transmitted at those angles, but that the UE 102 may determine the beam directions of beams 575 and 580 using such techniques as receive beam-forming, as receive directions. This situation may occur, for example, when a transmitted beam reflects from an object in the vicinity of the UE 102, and arrives at the UE 102 according to its reflected, rather than incident, angle.

In some embodiments, the UE 102 may transmit one or more channel state information (CSI) messages to the eNB 104 as reporting messaging. Embodiments are not limited to dedicated CSI messaging, however, as the UE 102 may include relevant reporting information in control messages or other types of messages that may or may not be dedicated for communication of the CSI-type information.

As an example, the first signal received from the first eNB 104 may include a first directional beam based at least partly on a first CSI-RS signal and a second directional beam based at least partly on a second CSI-RS signal. The UE 102 may determine a rank indicator (RI) for the first CSI-RS and an RI for the second CSI-RS, and may transmit both RIs in the CSI messages. In addition, the UE 102 may determine one or more RIs for the second signal, and may also include them in the CSI messages in some cases. In some embodiments, the UE 102 may also determine a CQI, a precoding matrix indicator (PMI), receive angles or other information for one or both of the first and second signals. Such information may be included, along with one or more RIs, in the one or more CSI messages. In some embodiments, the UE 102 performs reference signal receive power (RSRP) measurement, received signal strength indication (RSSI) measurement, reference signal receive quality (RSRQ) measurement, or some combination of these using CSI-RS signals.

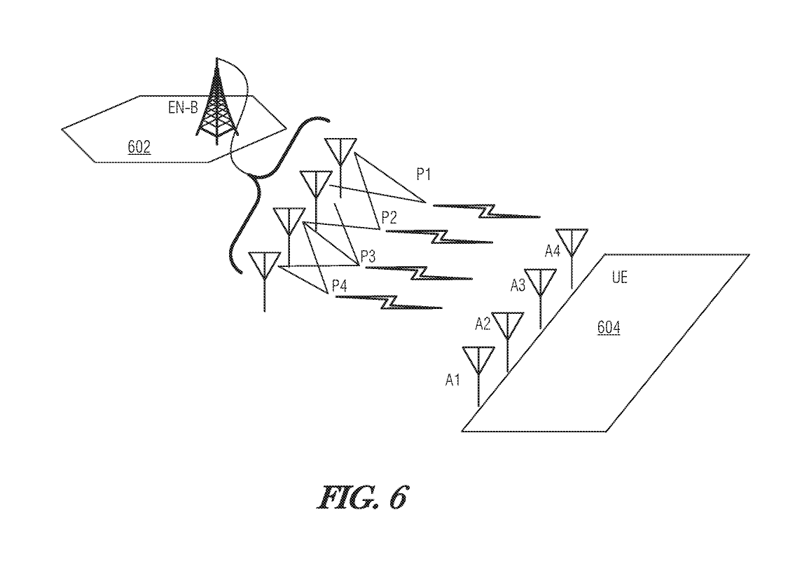

FIG. 6 is a diagram illustrating a MIMO transmission scenario utilizing an eNB and a UE, each having multiple antennas according to some embodiments, eNB 602 has multiple antennas, as depicted, which may be used in various groupings, and with various signal modifications for each grouping, to effectively produce a plurality of antenna ports P1-P4. In various embodiments within the framework of the illustrated example, each antenna port P1-P4 may be defined for 1, 2, 3, or 4 antennas. Each antenna port P1-P4 may correspond to a different transmission signal direction. Using the different antenna ports, eNB 602 may transmit multiple layers with codebook-based or non-codebook-based precoding techniques. According to some embodiments, each antenna port corresponds to a beam antenna port-specific CSI-RS signals are transmitted at via respective antenna port. In other embodiments, there may be more, or fewer, antenna ports available at the eNB than the four antenna ports as illustrated in FIG. 6.

On the UE side, there are a plurality of receive antennas. As illustrated in the example of FIG. 6, there four receive antennas, A1-A4. The multiple receive antennas may be used selectively to create receive beam forming. Receive beam forming may be used advantageously to increase the receive antenna gain for the direction(s) on which desired signals are received, and to suppress interference from neighboring cells, provided of course that the interference is received along different directions than the desired signals.

In various embodiments, beamforming, beam selection, and MIMO operations may be performed at eNB 300 by processing circuitry 306, transceiver circuitry 305, or some combination of these facilities. Likewise, in various embodiments, the beamforming, beam selection, and MIMO operations may be performed at UE 200 by application circuitry 202, baseband circuitry 204, Radio Frequency (RF) circuitry 206, or some combination of these facilities. In related embodiments, certain beam selection operations may be performed using distributed computing techniques, where certain information storage or processing operations are handled with the assistance of an external device, such as eNB 300, UE 200, or system 400.

Beamforming is a technique used in wireless communications for directional signal transmission and/or reception. It combines elements in a phased array in a way to constructively interfere with signals at certain angles while other angles experience destructive interference. In this manner, beamforming may concentrate a signal to a target location, e.g. the UE's location. The improvement compared with omnidirectional reception/transmission is known as the directional gain. Hybrid beamforming implements a digital unit with antenna ports processing digital signals and an analog beamforming unit with antenna elements processing analog signals. Each antenna port is connected to a subarray of several antenna elements and receives a digital signal filtered by the analog beamforming.

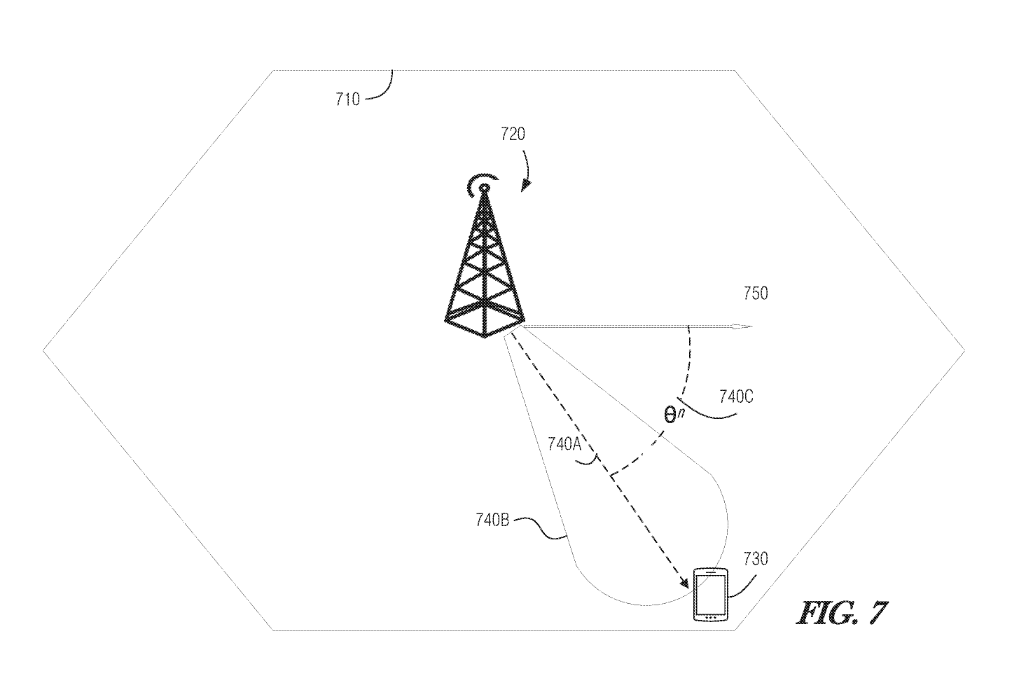

FIG. 7 is a diagram illustrating an exemplary communication network scenario in an aspect of this disclosure. In this scenario, a single beamforming direction and its corresponding beamforming area of the overall beamforming pattern will be discussed. It should be appreciated that the communication network scenario is exemplary in nature and thus may be simplified for purposes of this explanation.

E-node B 720 provides coverage to cell 710 and serves UEs in the coverage area by hybrid beamforming. In the structure of hybrid beamforming, there are N antenna ports (n=1, 2, . . . , N) at the base station eNB and each antenna port is connected to a subarray of M antenna elements (m=1, 2, . . . , M). Each antenna element has a phase shifter controlled by the analog beamforming parameters, such as beamforming weights. In this respect, each antenna port is connected to a phased array of antenna elements in which the relative phases of the respective signals feeding the antenna elements are set in such a way that each antenna port's effective beamforming radiation pattern is reinforced in a desired direction and suppressed in undesired directions.

Broadside 750 is the line from which locations (i.e. angles) in relation to the base station are measured from. Accordingly, the mobile terminal's 730 relative location to the base station 720 is the channel direction information (CDI). The base station 720 may be configured to form the beam towards the channel direction information, i.e. towards the channel.

Beamforming in the context of the present disclosure means beam steering towards a direction 740A of eNB antenna port n (not pictured) are at angle θn 740C as well as beam shaping, i.e. beam broadening corresponding to beamforming area 740B. It is appreciated that beamforming direction 740A is just one or a plurality of beamforming directions (and beamforming areas, e.g. 740B) which help to form the overall beamforming pattern from base station 720. It will also be appreciated that the main beam (or main lobe) of beamforming area 740B is depicted in FIG. 7, but beamforming area 740B may also include sidelobes.

In millimeter-wave communications system embodiments, highly directional transmission and reception techniques are employed using multiple antenna arrays and beamforming. In these embodiments, whenever a UE or wishes to connect with an eNB, the eNB would conventionally perform a sector sweep or sector scan (collectively, “SS”) operation where various beam directions are sequentially tested in some order until a suitable beam direction is found. Further optimization may be performed to improve the signal quality, adjust for movement of the UE, adjust for the movement of obstructing objects or other factors that impact the millimeter-wave beam propagation. In the present context, the terms sector sweep, and sector scan are used, sometimes interchangeably, with a distinction in their meanings being that a sector sweep proceeds in a spatially-consecutive fashion, such as clock-wise or counter-clockwise, whereas a sector scan may be disjointed, e.g., not necessarily performed in a spatially-consecutive fashion, although it may be in whole or in part.

Transmit sector sweep (TXSS) is used to determine a suitable beam direction for transmission at the eNB, whereas receive sector sweep (RXSS) is used to determine a suitable beam direction for reception at the UE. SS may also be used after a UE transitions operating modes from an idle mode to active mode after a prolonged duration of time. Because SS is an iterative process, it typically takes a number of attempts to find a suitable beam direction.

The short wavelengths of millimeter-wave communications makes it possible to deploy an antenna array having dozens of antenna elements to provide high gain, directionality, and narrow beam width. Given the high degree of directionality in millimeter-wave systems (e.g., using such techniques as digital codebook-based beamforming, analog beamforming, or some combination of the two classes of beamforming techniques) the operational scenario presents a large number of possible sectors, or beam directions, to test in a sector-sweep operation. In the present context, the term sector may be used interchangeably with the term beam direction. In addition, just as a beam may have a relatively narrower, or relatively wider radiation pattern, so too may a sector have a variable width.

In the initial-acquisition phase, several paradigms of device operation have been proposed. Category 1 (Cat1) UEs are considered un-calibrated for SS operations. Here, first the eNB directionally sweeps across the different TX beam directions and each UE listens in omnidirectional or wide-beam mode to select the eNB beam for reception. In the present context, the omnidirectional or wide-beam mode may be referred to as a low-directional-gain mode. Enhanced node-B transmit sector sweep (eNB-TXSS) is followed by a UE-TXSS procedure for the eNB to acquire the UE's selected TX beam, as well as for the UE to inform the eNB of its selected TX beam acquired by the UE during the eNB-TXSS stage. UEs may be simultaneously transmitting to reduce overhead assuming there are different “best” sectors for different UEs. However, even if different sectors are best for different UEs, collision probability is generally quite high due to the near-far effect.

Category 2 (Cat2) UEs have directional reciprocity, which can provide some degree of TX and RX SS calibration. For example, initial access procedures rely on an the UE receive SS procedure (UE-RXSS). Since directional reciprocity is present in this example, the eNB and the UE may use the same beam for TX as was selected for RX. In a Cat2 scenario, the UE gets timing information by eNB-TXSS; then, the UE performs UE-RXSS to determine its best UE beam direction for reception as well as transmission. Using the acquired beam index, the UE may access the eNB.

Category 3 (Cat3) UEs utilize full digital beamforming and reciprocity. For example, a Cat 3 UE may determine its transmit beamforming weights based on the eNB's digital beam-forming weights provided as part of a sync signal.

In case of Cat3 devices, channel estimation for each receive antenna may be the bottleneck for coherent combining and determination of the beamforming weights. Moreover, as the number of antenna elements to achieve the required beamforming gain is increased, it becomes infeasible from a power consumption and processing complexity standpoint to support a fully digital beamforming implementation (that would generally rely on having an RF chain per antenna element). Thus, aspects of some embodiments are directed to the first and second categories of devices.

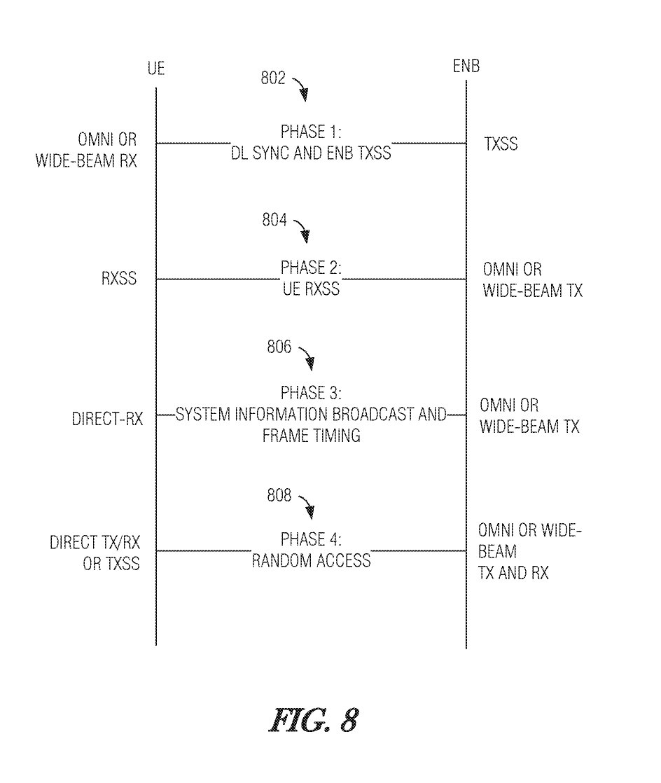

FIG. 8 is a high-level flow diagram illustrating a basic initial-acquisition process by which a UE and an eNB initiate communication according to some embodiments. In the example depicted, four phases 802, 804, 806, 808 are carried out. In phase 1 at 802, the UE uses its omnidirectional or wide-beam (i.e., low-directional-gain) mode to perform a downlink synchronization while the eNB performs transmit sector sweep TXSS using a high-directional-gain mode. The main objective of phase 1 802 is establishing timing between the eNB and the UE.

In phase 2 at 804, the UE performs a receive sector sweep RXSS while the eNB transmits signaling using a low-directional-gain mode to transmit signaling. Phase 2 utilizes the timing established in phase 1 to train the receiver of the UE. The eNB transmits a known sequence in a low-directional-gain mode, while the UE varies the receive BF weights of its high-directional-gain receive mode to cycle through the receive beam-direction sectors. As a result, the UE selects its receive BF direction using a measure such as signal-to-noise ratio (SNR) signal-to-interference-noise ratio (SINR), or the like. In phase 3 at 806, the eNB broadcasts system information using its low-directional-gain mode. The UE uses its high-directional-gain receive mode adjusted to its best receive BF direction to receive the broadcast system information.

Phase 4 at 808 provides a random-access channel on which the eNB transmits and receives using a low-directional-gain mode, and on which the UE either transmits or receives on its selected BF transmit and receive direction (if the best TX channel is known or is determinable based on the RX beam direction), or otherwise performs a transmit sector sweep TXSS. Whether or not the UE is able to use its best transmit BF direction immediately generally depends on whether the UE has the capability to ascertain its best transmit BF direction from other indicia, such as ascertained receive BF direction using a sector sweep operation such as, for instance, if the UE is calibrated to effectively use transmit-receive BF reciprocity. Cat2 UEs may have this capability, whereas Cat1 UEs generally lack the reciprocity capability.

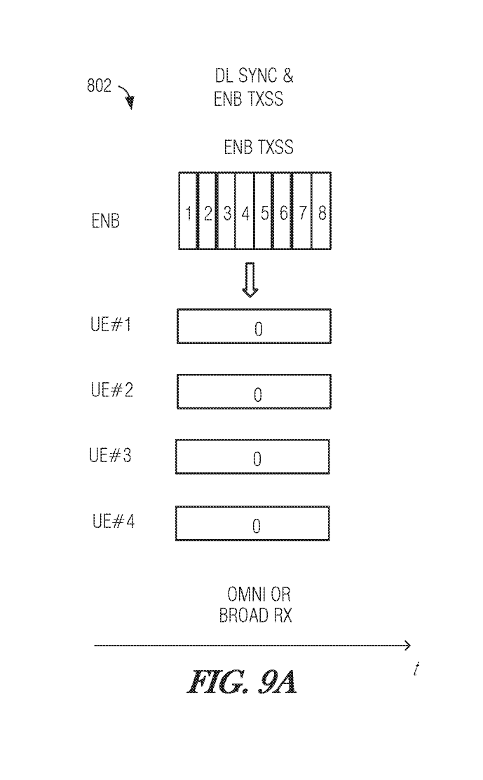

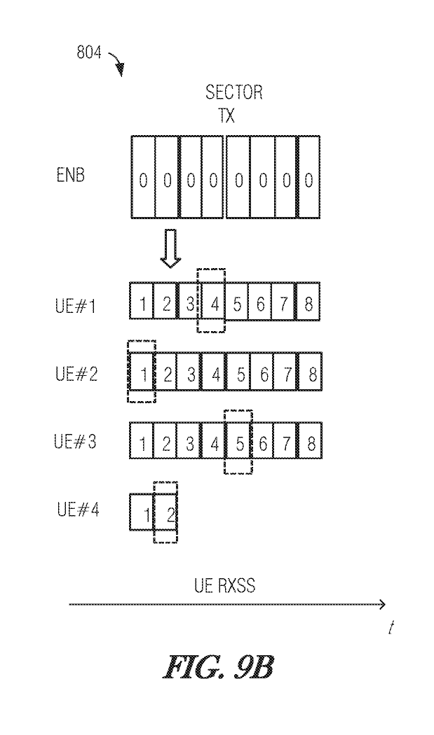

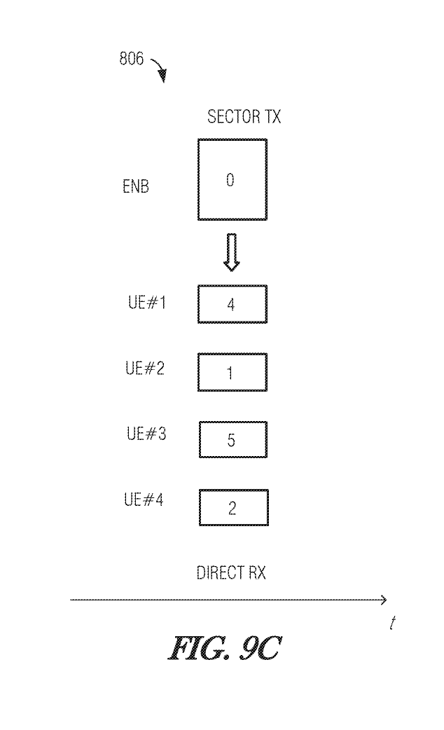

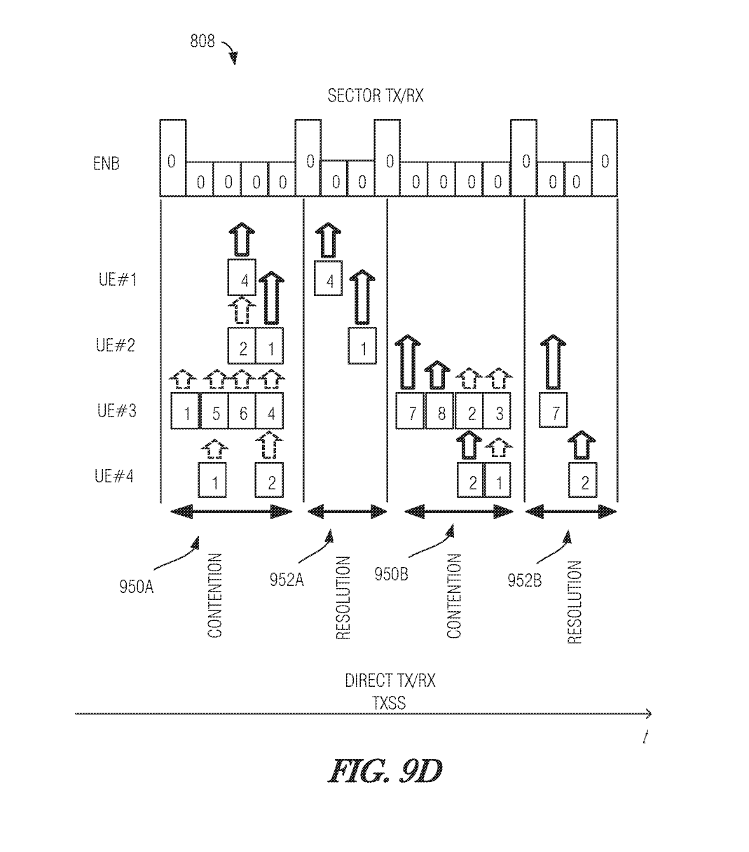

FIGS. 9A-9D are time-domain representations of phases 1-4, labeled 802-808, showing example transmission and reception operations using various BF directions (i.e., sectors) 1-8, and omnidirectional or wide-beam transmissions, which are labeled 0. The actions of the eNB are shown at the top of each diagram, and the actions of four UEs, labeled UE#1-UE#4, are shown in order below. The block arrows indicate the direction of transmission.

FIG. 9A illustrates phase 1 802. The eNB performs a transmit sector sweep, TXSS sequentially over 8 periods corresponding to the 8 BF directions 1-8, while UEs #1-#4 receive the transmissions using their omnidirectional or wide-beam modes. As indicated, the transmissions may include downlink synchronization signaling. FIG. 9B illustrates receive BF operations of the UEs 804, in which an omnidirectional transmission by the eNB while each UE, #1-#4, performs a receive sector sweep RXSS. As depicted, UEs #1-#3 each have eight BF directions 1-8 from which individual BF directions may be selected. In the example shown, the best-identified receive BF direction is indicated for each UE. For instance, UE#1 identified BF direction 4 as the best RX BF direction. Similarly, UEs 2-4 respectively identified BF directions 1, 5, and 2. FIG. 9C illustrates system information broadcast and frame timing operations 806 of phase 3, in which the eNB broadcasts the system information using a non-directional mode, while UEs #1-#4 each receives the transmission using its preferred receive BF direction.

FIG. 9D illustrates operations 808 of phase 4. As depicted, the eNB receives signaling using its non-directional mode. BF-directional transmissions by the UEs #1-#4 are received during contention periods 950A and 950B, and during resolution periods 952A and 952B. In some embodiments, each UE transmits at a random time slot within the contention period. Also, if the BF transmit direction is not known by a UE, the UE performs a transmit sector sweep through its available BF directions. The BF directions are sent in a randomized order, as depicted for UEs #3 and #4. The block arrows shown in solid lines represent successful communications, whereas the block arrows shown in broken lines represent failed communications. The length of the arrows represents the signal strength as received by the eNB.

In the example shown, UE#1 is calibrated for reciprocity; accordingly, UE#1 knows its transmit BF direction, which in this case is sector 4. UE #2 is partially calibrated, with a subset of candidate transmit BF directions 1 and 2. Thus, UE#2 tries the two BF directions, 1 and 2, during contention periods 950A and 950B. UE#3 is not calibrated; accordingly, it uses contention periods 950A and 950B to perform a TXSS operation with random-ordered beam directions 1, 5, 6, 4 in contention period 950A, and 7, 8, 2, 3 in contention period 950B. UE#4 is also not calibrated; accordingly, it also performs a TXSS operation in contention periods 950A and 950B with random ordering and slot selection for transmission of potential BF directions 1 and 2. In response to a successful communication from any UE to the eNB in a contention period 950A, 950B, that transmission is repeated in resolution period 952A. 952B, respectively.

In mmWave systems typically only a few of the beams transmitted from the UE achieve a high SNR at the eNB due to the high directionality of mmWave transmissions. Accordingly, it has been the conventional understanding that collisions between UE transmissions in the contention period are not likely. However, in practice, there remains a non-trivial collision incidence rate in contention periods 950A, 950B. Moreover, in situations where one or more UEs are in close proximity to the eNB with a line-of-sight transmission path available, the transmissions from these UEs may have a very high SNR, even for transmissions from BF directions that are not pointing to the eNB. Thus, the interfering signal may be present over many transmission slots. This example represents a significant collision problem since transmissions that can potentially interfere with other UEs are not limited to a narrow subset of the beam directions of the UE located near the eNB.

One aspect of the embodiments is directed to a power-control arrangement that reduces the probability of collisions when multiple UEs are simultaneously performing transmit BF sector sweep. Some embodiments are premised on the recognition that a primary objective of UE transmit sector sweep is to inform the eNB about the selected eNB sector for the UE, UE loading, etc., and providing a mechanism for the eNB to identify each UE's selected transmit sector (by way of the eNB listening to UE's sector sweep). Notably, to this end, the eNB only needs to identify each UE's best-performing transmit sector. The eNB does not need to decode each UE's transmissions across all UE BF directions.

According to some embodiments, an uplink power control arrangement operates to permit a UE's selected beam (or several selected beams as a subset of all supported beam directions by the UE) to achieve high SNR at the eNB while any resulting interference to other UEs occurring as a side-effect of the signal transmissions across other time slots and other beams is significantly reduced. The one or several selected beams may be the beams determined to be the best-performing beams, for example. Advantageously, a technical effect of the uplink power control arrangement is an effective reduction in the average number of contending UEs at each time slot, such that the overall collision probability is reduced.

According to some embodiments, a UE estimates the received power in dB, of its transmissions as received at the eNB, based on the following formula:

Received Power_{eNB}=Pt(UE)+Gt(UE)+Gr(eNB)−PL−NF(eNB) (1)

Here, Pt(UE) is the UE transmit power (in dBm) and is the variable controlled by the UE such that a targeted received power is achieved at the eNB. Gt(UE) represents the antenna gain at the UE, which is a function of the number of UE antennas, the gain per antenna, and the UE pointing direction, among others factors. Gr(eNB) represents the antenna gain at the eNB, which is a function of the eNB antennas and per-antenna gain, among other factors. PL is the path loss value between the transmitter and receiver, and NF(eNB) is the noise figure at the eNB.

A similar formula can be written for the downlink is expressed as:

Received Power_{UE}=Pt(eNB)+Gt(BS)+Gr(UE)−PL−NF(UE) (2)

Applying Equation (1) above, a UE according to some embodiments determines an optimal transmission power Pt-OPT(UE) to achieve a targeted SNR at the eNB using its best beam, if Gt(UE), Gr(eNB), PL, and NF(eNB) are known (or estimated) at the UE.

In a related embodiment, a power control arrangement is implemented by each UE such that each UE's best beam achieves a targeted signal characteristic, such as SNR, at the eNB. A given UE's best beam is the UE beam (which may be expressed as a BF index) that achieves the highest SNR at the eNB for a fixed transmission power across all UE BF directions.

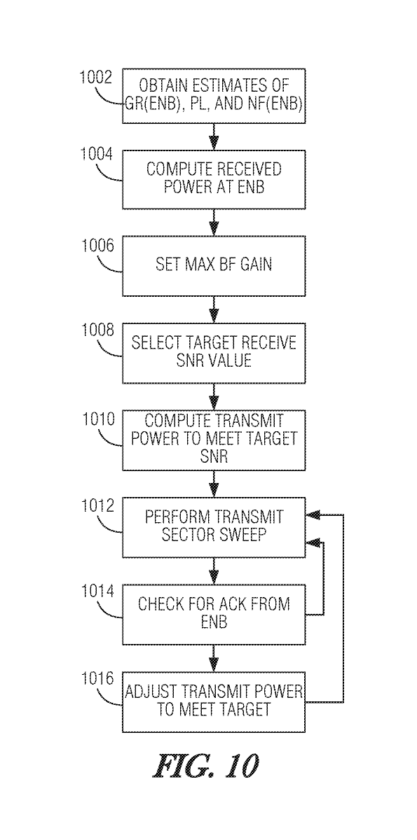

FIG. 10 is a flow diagram illustrating operations performed by a UE to apply a power control arrangement according to some example embodiments. At 1002, the UE obtains values of Gr(eNB), PL, and NF(eNB). One or more of these values may be estimated, rather than actually measured. Various embodiments for obtaining these values are described below. At 1004, received power at the eNB is computed based on the estimates using Equation (1). At 1006, the UE sets its maximum possible BF gain, and uses this value to represent Gt(UE) in Equation (1).

At 1008, the UE selects an appropriate targeted SNR value to use in Equation (1). The targeted SNR value is selected such that the UE's best beam can be received with sufficient strength to be decoded at the eNB, taking into account a moderate level of interference. For instance, a predefined targeted SNR threshold may be set to −3 dB in light-to-moderately dense deployments, and 0 dB in dense deployments.

In a related embodiment, the targeted SNR value includes an additional reliability margin to cover the possibility of inaccurate transmit or receive beam gain estimations or other inaccuracies at the eNB. The additional reliability margin may be on the order of 2-3 dB as an example.

In some embodiments, the targeted SNR value is preconfigured in the UE. In another embodiment, the targeted SNR value is system-defined, and configured in the UE by the eNB. In a related embodiment, the UE is preconfigured, or system-configured to dynamically adjust the targeted SNR value based on various factors, such as the time to confirm signal transmission from the UE to the eNB in the contention periods of phase 4 808. For instance, if the time to receive a confirmation is longer than a predefined number of resolution cycles 952, then the targeted SNR value may be increased by the UE.

At 1010, the transmit power Pt-OPT(UE) to meet the targeted SNR value is computed based on the determined values of Gt(UE), Gr(eNB). PL. NF(eNB), and targeted SNR. The computed transmit power setting is applied to all selected BF directions during UE transmit sector sweep at 1012.

At 1014, during the sector sweep, the UE checks for acknowledgement messaging from the eNB, which indicates the actual received SNR at the eNB to the UE. It is possible that no acknowledgement is provided to the UE for all of the BF directions tested in the sector sweep, which indicates to the UE that the transmit power is not sufficient. On the other extreme, the received SNR may be far in excess of the targeted value. Accordingly, at 1016, the transmit power is adjusted to bring the actual measured SNR at the eNB toward to the targeted receive SNR.

The adjustment may be applied to the next contention period. In an example embodiment, the adjustment is made incrementally, with the step size, or rate of adjustment, such as the number of contention rounds that a UE is allowed to increase its power, being limited by the operator network or being a fixed value specified by a standard.

According to various embodiments, the UE obtains the values of Gr(eNB), PL, and NF(eNB), or their estimates, in a variety of ways. In one such embodiment, the eNB includes certain information as part of its sector-sweep signaling. This included information enables UEs to calculate Gr(eNB), PL, and NF(eNB).

In one example, the eNB may explicitly inform UEs about its noise figure (NF(eNB)) and its receive antenna gain (Gr(eNB)) that would be employed later during UE transmit sector sweep. This is achieved by eNB putting this information on each of its beams during eNB transmit sector sweep.

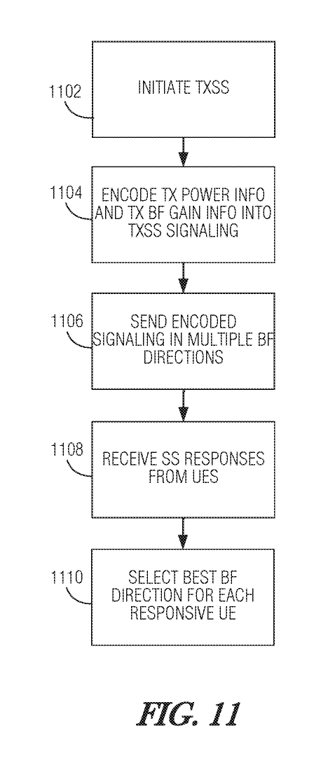

FIG. 11 is a flow diagram illustrating a transmit sector sweep (TXSS) process carried out by an eNB according to some embodiments. The process may be carried out as part of phase 1 802, for example. At 1102, the eNB initiates the TXSS operations. At 1104, TXSS signaling is encoded, including incorporating transmission power (Pt(eNB)) and maximum transmit beamforming gain (Gt(eNB)) into each of its BF directional signals. At 1106, the eNB sends the encoded signaling on each of the BF directions as part of the sector-sweep operation. At 1108, the eNB receives responsive signaling from UEs that receive the signaling, which informs the eNB as to the BF directions to use for communicating with those UEs. Accordingly, at 1110, the eNB selects the best BF direction for each responsive UE.

In an example embodiment, a UE receiving the eNB's TXSS signaling may measure its highest receive SNR during eNB transmit sector sweep and compute the path loss from Equation (2) given that the highest measured SNR, eNB transmit power (Pt(eNB)), beamforming gain (Gt(eNB)), UE receive beamforming gain (Gr(UE)), and UE noise figure (NF(UE)) values are all known.

In a related embodiment, Gr(UE) is the highest beamforming gain that the UE can receive using its antenna configuration for receiving the eNB's TXSS signaling. For omnidirectional or wide-beam reception modes, the beamforming gain Gr(UE) may be significantly lower than in a directional receive mode. In the context of the protocol of FIGS. 8-9A-D, the UE uses a wide or omnidirectional beam for listening to the eNB's TXSS signaling. However, it will be understood that other protocols are contemplated in which the UE determines a receive BF direction prior to execution of the eNB TXSS, and uses the received BF direction for receiving the eNB TXSS signaling.

In other example embodiments, the UE and eNB use the same antenna gains for channel and receive power estimation are used for UE transmission in the contention periods. For instance, a secondary synchronization signal (SSS) may be used by the UE to determine its best receive BF direction. This example is illustrated above with reference to phase 2 804 and in FIG. 9B. Notably, the signaling from the eNB in this example is a SSS. Notably, in phases 2 and 4 804, 808, the UE antenna configuration is high-gain for narrow beam width, whereas the eNB antenna configuration is omnidirectional or wide-beam for a low antenna gain. In such a symmetric arrangement, the transmit and receive antenna gains are the same for both SSS and random-access channels in phases 2 and 4 respectively. As a result, the UE may forgo explicitly estimating these values or PL in Equation (1) (since Gt(eNB)=Gr(eNB) and Gt(UE)=Gr(UE) and uplink PL=downlink PL). Subtracting Equations (1) and (2) provides:

RxPower_{eNB}−RxPower_{UE}=Pt(UE)−NF(eNB)−Pt(eNB)+NF(UE) (3)

Here, the RxPower at the UE is the maximum measured receive power at the UE during the eNB transmit sector sweep. Therefore, a UE may calculate its optimal transmit power that achieves a desired SNR at the eNB if the eNB-specific parameters (NF(eNB) and Pt(eNB)) are known. In general, the UE maintains an estimate of its own noise figure value NF(UE). The eNB-specific parameters needed by the UE for computing Equation (3) may be provided by the eNB at any suitable point in the protocol prior to the RACH channel in phase 4 808. For example, the eNB may explicitly announce this information on each of its scanned beams during its transmit sector sweep in phase 1 802, in the signaling during the UE receive sector sweep in phase 3 804, or in the system information broadcast using a broadcast channel (BCH) in phase 3 806.

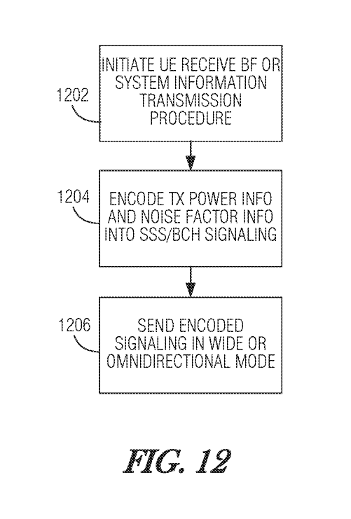

FIG. 12 is a flow diagram illustrating an example process performed by an eNB for providing channel parameters to UEs according to some embodiments. At 1202, the eNB initiates a transmission procedure to send signaling using an omnidirectional or wide-beam mode. The procedure may be a SSS as in phase 2 804, or a BCH transmission as in phase 3 806, for example. At 1204, the eNB encodes TX power Pt(eNB) information and noise factor NF(eNB) information in the signaling to be sent. At 1206, the encoded signaling is sent using wide-beam or omnidirectional mode.

In another aspect of the embodiments, the UE and eNB may use another radio access technology (RAT), such as LTE or Wi-Fi, to help exchange relevant parameters for the power control arrangement. In an example, each mmWave eNB uses the LTE RAT to explicitly inform the UE regarding the eNB noise figure NF(eNB), and eNB receive beam gain Gr(eNB).

In a related aspect, when the LTE RAT is co-located with the mmWave RAT at the eNB and UE, the path loss component (PL) can also be estimated by first measuring the path loss at the LTE frequency band, and then applying models (e.g., assuming free space path loss model or other suitable models, to estimate the corresponding path loss at the mmWave band. These operations may be performed by the UE, the eNB, or both, according to various embodiments.

### Additional Notes and Examples

Example 1 is apparatus of user equipment (UE) configurable for radio-frequency power control in a beamforming arrangement, the apparatus comprising: memory; and processing circuitry to: encode signaling for sector-sweep transmission to a base station via a plurality of directional beams in a millimeter-wave radio band over a random-access shared channel during at least one contention period; determine a transmission power setting for the sector-sweep transmission, the transmission power setting being based on a targeted received signal characteristic to be achieved at the base station using a selected beam direction, wherein the transmission power setting is determined based on transmission parameters of the UE and reception parameters of the base station, and on channel characteristics; and initiate transmission of the signaling using the transmission power setting for the plurality of directional beams, wherein the signaling is transmitted to be received according to a targeted received signal characteristic to be achieved at the base station.

In Example 2, the subject matter of Example 1 optionally includes wherein the targeted received signal characteristic to be achieved includes a defined signal-to-noise (SNR) ratio for the selected beam to be directionally transmitted to the base station.

In Example 3, the subject matter of any one or more of Examples 1-2 optionally include wherein the reception parameters of the base station include estimated values.

In Example 4, the subject matter of any one or more of Examples 1-3 optionally include wherein the reception parameters of the base station include a base station noise figure, and a base station receive antenna gain.

In Example 5, the subject matter of any one or more of Examples 1-4 optionally include wherein the channel characteristics include path loss.

In Example 6, the subject matter of any one or more of Examples 1-5 optionally include wherein the transmission parameters of the UE include a UE noise figure and a UE transmit antenna gain.

In Example 7, the subject matter of any one or more of Examples 1-6 optionally include wherein the targeted received signal characteristic to be achieved at the base station includes a reliability margin addition.

In Example 8, the subject matter of any one or more of Examples 1-7 optionally include wherein the processing circuitry is to receive, from an external source, transmit power of the base station, and a noise figure of the base station.

In Example 9, the subject matter of any one or more of Examples 1-8 optionally include wherein the processing circuitry is to receive, from an external source, at least one information item from among: receive antenna gain information of the base station, path loss of the channel characteristics, and a noise figure of the base station.

In Example 10, the subject matter of Example 9 optionally includes wherein the external source is the base station.

In Example 11, the subject matter of Example 10 optionally includes wherein the at least one information item is received via base station transmit sector sweep signaling.

In Example 12, the subject matter of any one or more of Examples 10-11 optionally include wherein the at least one information item is received via base station secondary synchronization signaling (SSS).

In Example 13, the subject matter of any one or more of Examples 9-12 optionally include wherein the at least one information item is received via a non-millimeter-wave radio-access technology.

In Example 14, the subject matter of any one or more of Examples 1-13 optionally include wherein the transmission power setting is computed based on a UE transmit antenna gain value, a base station receive antenna gain value, path loss of the channel, noise figure at the base station, and the targeted received signal characteristic to be achieved.

In Example 15, the subject matter of any one or more of Examples 1-14 optionally include wherein the processor is to dynamically incrementally adjust the transmission power setting in in response to a determined failure of communication with the base station.

In Example 16, the subject matter of any one or more of Examples 1-15 optionally include wherein the apparatus further includes radio transceiver circuitry operatively coupled to a set of antenna elements.

In Example 17, the subject matter of any one or more of Examples 1-16 optionally include wherein the millimeter-wave radio band includes frequencies between 50 GHz and 80 GHz.

Example 18 is apparatus of a base station configurable for radio-frequency beamforming in a millimeter-wave band, the apparatus comprising: memory; and processing circuitry to: establish a random-access shared channel protocol in which contention periods are defined during which a plurality of user equipment (UE) devices are to send connection-establishment signaling to the base station using respective directional transmissions; and prior to execution of the random-access shared channel protocol, encode base station-specific communications performance parameters for transmission to the plurality UE devices, the communications performance parameters including at least base station transmit power and base station noise figure information, wherein each of the UE devices is to determine a transmission power setting for their respective directional transmissions; and receive the connection-establishment signaling from individual ones of the plurality of UE devices during the contention periods, the connection-establishment signaling being transmission-power controlled independently by the respective UE devices based on a targeted received signal characteristic to be achieved at the base station using a selected beam direction of the respective UE devices, wherein the respective UE devices determine the transmission power setting based on their own transmission and reception parameters, on channel characteristics, and on the base station-specific communications performance parameters.

In Example 19, the subject matter of Example 18 optionally includes wherein the base station-specific communications performance parameters are to be transmitted via a plurality of directional beams during a sector sweep operation of the base station.

In Example 20, the subject matter of any one or more of Examples 18-19 optionally include wherein the base station-specific communications performance parameters are to be transmitted by the base station via a wide-beam transmission during a receive sector sweep operation of respective UE devices.

In Example 21, the subject matter of any one or more of Examples 18-20 optionally include wherein the base station-specific communications performance parameters are to be transmitted by the base station via a wide-beam transmission during a system information broadcast by the base station.

In Example 22, the subject matter of any one or more of Examples 18-21 optionally include wherein the base station-specific communications performance parameters are to be transmitted by the base station via base station secondary synchronization signaling (SSS).

In Example 23, the subject matter of any one or more of Examples 18-22 optionally include wherein the base station-specific communications performance parameters include a base station receive antenna gain.

In Example 24, the subject matter of any one or more of Examples 18-23 optionally include wherein the at least one information item is received via a non-millimeter-wave radio-access technology.

In Example 25, the subject matter of any one or more of Examples 18-24 optionally include wherein the millimeter-wave band includes frequencies between 50 GHz and 80 GHz.

In Example 26, the subject matter of any one or more of Examples 18-25 optionally include wherein the apparatus further includes radio transceiver circuitry operatively coupled to a set of antenna elements.

In Example 27, the subject matter of any one or more of Examples 18-26 optionally include wherein the base station is an evolved node-B (eNB) base station.

In Example 28, the subject matter of any one or more of Examples 18-27 optionally include wherein the base station is a wireless access point (AP).

Example 29 is at least one machine-readable medium containing instructions that, when executed on a processor of user equipment (UE) configurable for radio-frequency power control in a beamforming arrangement, cause the UE to: encode signaling for sector-sweep transmission to a base station via a plurality of directional beams in a millimeter-wave radio band over a random-access shared channel during at least one contention period; determine a transmission power setting for the directional beams of the sector-sweep transmission, the transmission power setting being based on a targeted received signal characteristic to be achieved at the base station using a selected beam direction, wherein the transmission power setting is determined based on transmission parameters of the UE and reception parameters of the base station, and on channel characteristics; and initiate transmission of the signaling using the transmission power setting for the plurality of directional beams, wherein the signaling is transmitted to be received according to a targeted received signal characteristic to be achieved at the base station.

In Example 30, the subject matter of Example 29 optionally includes wherein the targeted received signal characteristic to be achieved includes a defined signal-to-noise (SNR) ratio for the selected beam to be directionally transmitted to the base station.

In Example 31, the subject matter of any one or more of Examples 29-30 optionally include wherein the reception parameters of the base station include estimated values.

In Example 32, the subject matter of any one or more of Examples 29-31 optionally include wherein the reception parameters of the base station include a base station noise figure, and a base station receive antenna gain.

In Example 33, the subject matter of any one or more of Examples 29-32 optionally include wherein the channel characteristics include path loss.

In Example 34, the subject matter of any one or more of Examples 29-33 optionally include wherein the transmission parameters of the UE include a UE noise figure and a UE transmit antenna gain.

In Example 35, the subject matter of any one or more of Examples 29-34 optionally include wherein the targeted received signal characteristic to be achieved at the base station includes a reliability margin addition.

In Example 36, the subject matter of any one or more of Examples 29-35 optionally include wherein the instructions are to cause the processor to receive, from an external source, transmit power of the base station, and a noise figure of the base station.

In Example 37, the subject matter of any one or more of Examples 29-36 optionally include wherein the instructions are to cause the processor to receive, from an external source, at least one information item from among: receive antenna gain information of the base station, path loss of the channel characteristics, and a noise figure of the base station.

In Example 38, the subject matter of Example 37 optionally includes wherein the at least one information item is to be received via base station transmit sector sweep signaling.

In Example 39, the subject matter of any one or more of Examples 37-38 optionally include wherein the at least one information item is to be received via base station secondary synchronization signaling (SSS).

In Example 40, the subject matter of any one or more of Examples 37-39 optionally include wherein the at least one information item is received via a non-millimeter-wave radio-access technology.

In Example 41, the subject matter of any one or more of Examples 29-40 optionally include wherein the transmission power setting is computed based on a UE transmit antenna gain value, a base station receive antenna gain value, path loss of the channel, noise figure at the base station, and the targeted received signal characteristic to be achieved.

In Example 42, the subject matter of any one or more of Examples 29-41 optionally include wherein the instructions are to cause the processor to dynamically incrementally adjust the transmission power setting in in response to a determined failure of communication with the base station.

In Example 43, the subject matter of any one or more of Examples 29-42 optionally include wherein the millimeter-wave radio band includes frequencies between 50 GHz and 80 GHz.

Example 44 is at least one machine-readable medium of a base station configurable for millimeter-wave radio-frequency beamforming, the at least one machine-readable medium comprising instructions that, when executed by a processor of the base station, cause the base station to: establish a random-access shared channel protocol in which contention periods are defined during which a plurality of user equipment (UE) devices are to send connection-establishment signaling to the base station using respective directional transmissions; and prior to execution of the random-access shared channel protocol, encode base station-specific communications performance parameters for transmission to the plurality UE devices, the communications performance parameters including at least base station transmit power and base station noise figure information, wherein each of the UE devices is to determine a transmission power setting for the directional transmissions of the connection-establishment signaling; and receive the connection-establishment signaling from individual ones of the plurality of UE devices during the contention periods, the connection-establishment signaling being transmission-power controlled independently by the respective UE devices based on a targeted received signal characteristic to be achieved at the base station using a selected beam direction of the respective UE devices, wherein the respective UE devices determine the transmission power setting based on their own transmission and reception parameters, on channel characteristics, and on the base station-specific communications performance parameters.

In Example 45, the subject matter of Example 44 optionally includes wherein the base station-specific communications performance parameters are to be transmitted via a plurality of directional beams during a sector sweep operation of the base station.

In Example 46, the subject matter of any one or more of Examples 44-45 optionally include wherein the base station-specific communications performance parameters are to be transmitted by the base station via a wide-beam transmission during a receive sector sweep operation of respective UE devices.

In Example 47, the subject matter of any one or more of Examples 44-46 optionally include wherein the base station-specific communications performance parameters are to be transmitted by the base station via a wide-beam transmission during a system information broadcast by the base station.

In Example 48, the subject matter of any one or more of Examples 44-47 optionally include wherein the base station-specific communications performance parameters are to be transmitted by the base station via base station secondary synchronization signaling (SSS).

In Example 49, the subject matter of any one or more of Examples 44-48 optionally include wherein the base station-specific communications performance parameters include a base station receive antenna gain.

In Example 50, the subject matter of any one or more of Examples 44-49 optionally include wherein the base station-specific communications performance parameters are to be transmitted via a non-millimeter-wave radio-access technology.

In Example 51, the subject matter of any one or more of Examples 44-50 optionally include wherein the millimeter-wave beam-forming includes frequencies between 50 GHz and 80 GHz.

Example 52 is apparatus of user equipment (UE) configurable for radio-frequency power control in a beamforming arrangement, the apparatus comprising: means for encoding signaling for sector-sweep transmission to a base station via a plurality of directional beams in a millimeter-wave radio band over a random-access shared channel during at least one contention period; means for determining a transmission power setting for the directional beams of the sector-sweep transmission, the transmission power setting being based on a targeted received signal characteristic to be achieved at the base station using a selected beam direction, wherein the transmission power setting is determined based on transmission parameters of the UE and reception parameters of the base station, and on channel characteristics; and means for initiating transmission of the signaling using the transmission power setting for the plurality of directional beams, wherein the signaling is transmitted to be received according to a targeted received signal characteristic to be achieved at the base station.

In Example 53, the subject matter of Example 52 optionally includes wherein the targeted received signal characteristic to be achieved includes a defined signal-to-noise (SNR) ratio for the selected beam to be directionally transmitted to the base station.

In Example 54, the subject matter of any one or more of Examples 52-53 optionally include wherein the reception parameters of the base station include estimated values.

In Example 55, the subject matter of any one or more of Examples 52-54 optionally include wherein the reception parameters of the base station include a base station noise figure, and a base station receive antenna gain.

In Example 56, the subject matter of any one or more of Examples 52-55 optionally include wherein the channel characteristics include path loss.

In Example 57, the subject matter of any one or more of Examples 52-56 optionally include wherein the transmission parameters of the UE include a UE noise figure and a UE transmit antenna gain.

In Example 58, the subject matter of any one or more of Examples 52-57 optionally include wherein the targeted received signal characteristic to be achieved at the base station includes a reliability margin addition.

In Example 59, the subject matter of any one or more of Examples 52-58 optionally include means for receiving, from an external source, transmit power of the base station, and a noise figure of the base station.

In Example 60, the subject matter of any one or more of Examples 52-59 optionally include means for receiving, from an external source, at least one information item from among: receive antenna gain information of the base station, path loss of the channel characteristics, and a noise figure of the base station.

In Example 61, the subject matter of Example 60 optionally includes wherein the external source is the base station.

In Example 62, the subject matter of Example 61 optionally includes wherein the at least one information item is received via base station transmit sector sweep signaling.

In Example 63, the subject matter of any one or more of Examples 61-62 optionally include wherein the at least one information item is received via base station secondary synchronization signaling (SSS).

In Example 64, the subject matter of any one or more of Examples 60-63 optionally include wherein the at least one information item is received via a non-millimeter-wave radio-access technology.

In Example 65, the subject matter of any one or more of Examples 52-64 optionally include wherein the transmission power setting is computed based on a UE transmit antenna gain value, a base station receive antenna gain value, path loss of the channel, noise figure at the base station, and the targeted received signal characteristic to be achieved.

In Example 66, the subject matter of any one or more of Examples 52-65 optionally include means for dynamically incrementally adjusting the transmission power setting in in response to a determined failure of communication with the base station.

In Example 67, the subject matter of any one or more of Examples 52-66 optionally include wherein the millimeter-wave radio band includes frequencies between 50 GHz and 80 GHz.

In Example 68, the subject matter of any one or more of Examples 52-67 optionally include wherein the apparatus further includes radio transceiver circuitry operatively coupled to a set of antenna elements.

Example 69 is apparatus of a base station configurable for millimeter-wave radio-frequency beamforming, the apparatus comprising: means for establishing a random-access shared channel protocol in which contention periods are defined during which a plurality of user equipment (UE) devices are to send connection-establishment signaling to the base station using respective directional transmissions; and means for encoding base station-specific communications performance parameters, prior to execution of the random-access shared channel protocol, for transmission to the plurality UE devices, the communications performance parameters including at least base station transmit power and base station noise figure information, wherein each of the UE devices is to determine a transmission power setting for the directional transmission; and means for receiving the connection-establishment signaling from individual ones of the plurality of UE devices during the contention periods, the connection-establishment signaling being transmission-power controlled independently by the respective UE devices based on a targeted received signal characteristic to be achieved at the base station using a selected beam direction of the respective UE devices, wherein the respective UE devices determine the transmission power setting based on their own transmission and reception parameters, on channel characteristics, and on the base station-specific communications performance parameters.

In Example 70, the subject matter of Example 69 optionally includes wherein the base station-specific communications performance parameters are to be transmitted via a plurality of directional beams during a sector sweep operation of the base station.

In Example 71, the subject matter of any one or more of Examples 69-70 optionally include wherein the base station-specific communications performance parameters are to be transmitted by the base station via a wide-beam transmission during a receive sector sweep operation of respective UE devices.

In Example 72, the subject matter of any one or more of Examples 69-71 optionally include wherein the base station-specific communications performance parameters are to be transmitted by the base station via a wide-beam transmission during a system information broadcast by the base station.

In Example 73, the subject matter of any one or more of Examples 69-72 optionally include wherein the base station-specific communications performance parameters are to be transmitted by the base station via base station secondary synchronization signaling (SSS).

In Example 74, the subject matter of any one or more of Examples 69-73 optionally include wherein the base station-specific communications performance parameters include a base station receive antenna gain.

In Example 75, the subject matter of any one or more of Examples 69-74 optionally include wherein the base station-specific communications performance parameters are to be transmitted via a non-millimeter-wave radio-access technology.

In Example 76, the subject matter of any one or more of Examples 69-75 optionally include wherein the apparatus further includes radio transceiver circuitry operatively coupled to a set of antenna elements.

In Example 77, the subject matter of any one or more of Examples 69-76 optionally include wherein the base station is an evolved node-B (eNB) base station.

In Example 78, the subject matter of any one or more of Examples 69-77 optionally include wherein the base station is a wireless access point (AP).

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

What is claimed is:

1. Apparatus of user equipment (UE) configurable for radio-frequency power control in a beamforming arrangement, the apparatus comprising:
memory; and
processing circuitry to:
encode signaling for sector-sweep transmission to a base station via a plurality of directional beams in a millimeter-wave radio band over a random-access shared channel during at least one contention period;
determine a transmission power setting for the directional transmission, the transmission power setting being based on a targeted received signal characteristic to be achieved at the base station using a selected beam direction, wherein the transmission power setting is determined based on transmission parameters of the UE and reception parameters of the base station, and on channel characteristics; and
initiate transmission of the signaling using the transmission power setting for the plurality of directional beams, wherein the signaling is transmitted to be received according to a targeted received signal characteristic to be achieved at the base station.

2. The apparatus of claim 1, wherein the reception parameters of the base station include estimated values.

3. The apparatus of claim 1, wherein the reception parameters of the base station include a base station noise figure, and a base station receive antenna gain.

4. The apparatus of claim 1, wherein the channel characteristics include path loss.

5. The apparatus of claim 1, wherein the transmission parameters of the UE include a UE noise figure and a UE transmit antenna gain.

6. The apparatus of claim 1, wherein the targeted received signal characteristic to be achieved at the base station includes a reliability margin addition.

7. The apparatus of claim 1, wherein the processing circuitry is to receive, from an external source, transmit power of the base station, and a noise figure of the base station.

8. The apparatus of claim 1, wherein the processing circuitry is to receive, from an external source, at least one information item from among: receive antenna gain information of the base station, path loss of the channel characteristics, and a noise figure of the base station.

9. The apparatus of claim 8, wherein the at least one information item is received via a non-millimeter-wave radio-access technology.

10. Apparatus of a base station configurable for radio-frequency beamforming, the apparatus comprising:
memory; and
processing circuitry to:
establish a random-access shared channel protocol in which contention periods are defined during which a plurality of user equipment (UE) devices are to send connection-establishment signaling to the base station using respective directional transmissions; and
prior to execution of the random-access shared channel protocol, encode base station-specific communications performance parameters for transmission to the plurality UE devices, the communications performance parameters including at least base station transmit power and base station noise figure information, wherein each of the UE devices is to determine a transmission power setting for the directional transmission; and
receive the connection-establishment signaling from individual ones of the plurality of UE devices during the contention periods, the connection-establishment signaling being transmission-power controlled independently by the respective UE devices based on a targeted received signal characteristic to be achieved at the base station using a selected beam direction of the respective UE devices, wherein the respective UE devices determine the transmission power setting based on their own transmission and reception parameters, on channel characteristics, and on the base station-specific communications performance parameters.

11. The apparatus of claim 10, wherein the base station-specific communications performance parameters are to be transmitted via a plurality of directional beams during a sector sweep operation of the base station.

12. The apparatus of claim 10, wherein the base station-specific communications performance parameters are to be transmitted by the base station via a wide-beam transmission during a receive sector sweep operation of respective UE devices.

13. The apparatus of claim 10, wherein the base station-specific communications performance parameters are to be transmitted by the base station via a wide-beam transmission during a system information broadcast by the base station.

14. The apparatus of claim 10, wherein the base station-specific communications performance parameters are to be transmitted by the base station via base station secondary synchronization signaling (SSS).

15. The apparatus of claim 10, wherein the base station-specific communications performance parameters include a base station receive antenna gain.

16. The apparatus of claim 10, wherein the base station-specific communications performance parameters are to be transmitted via a non-millimeter-wave radio-access technology.

17. At least one machine-readable medium containing instructions that, when executed on a processor of user equipment (UE) configurable for radio-frequency power control in a beamforming arrangement, cause the UE to:
encode signaling for sector-sweep transmission to a base station via a plurality of directional beams in a millimeter-wave radio band over a random-access shared channel during at least one contention period;
determine a transmission power setting for the directional transmission, the transmission power setting being based on a targeted received signal characteristic to be achieved at the base station using a selected beam direction, wherein the transmission power setting is determined based on transmission parameters of the UE and reception parameters of the base station, and on channel characteristics; and
initiate transmission of the signaling using the transmission power setting for the plurality of directional beams, wherein the signaling is transmitted to be received according to a targeted received signal characteristic to be achieved at the base station.

18. The at least one machine-readable medium of claim 17, wherein the reception parameters of the base station include a base station noise figure, and a base station receive antenna gain.

19. The at least one machine-readable medium of claim 17, wherein the channel characteristics include path loss.

20. The at least one machine-readable medium of claim 17, wherein the transmission parameters of the UE include a UE noise figure and a UE transmit antenna gain.

21. The at least one machine-readable medium of claim 17, wherein the targeted received signal characteristic to be achieved at the base station includes a reliability margin addition.

22. The at least one machine-readable medium of claim 17, wherein the instructions are to cause the processor to receive, from an external source, transmit power of the base station, and a noise figure of the base station.

23. The at least one machine-readable medium of claim 17, wherein the instructions are to cause the processor to receive, from an external source, at least one information item from among: receive antenna gain information of the base station, path loss of the channel characteristics, and a noise figure of the base station.

24. The at least one machine-readable medium of claim 23, wherein the at least one information item is received via a non-millimeter-wave radio-access technology.

25. At least one machine-readable medium of a base station configurable for radio-frequency beamforming, the at least one machine-readable medium comprising instructions that, when executed by a processor of the base station, cause the base station to:
establish a random-access shared channel protocol in which contention periods are defined during which a plurality of user equipment (UE) devices are to send connection-establishment signaling to the base station using respective directional transmissions; and
prior to execution of the random-access shared channel protocol, encode base station-specific communications performance parameters for transmission to the plurality UE devices, the communications performance parameters including at least base station transmit power and base station noise figure information, wherein each of the UE devices is to determine a transmission power setting for the directional transmission; and
receive the connection-establishment signaling from individual ones of the plurality of UE devices during the contention periods, the connection-establishment signaling being transmission-power controlled independently by the respective UE devices based on a targeted received signal characteristic to be achieved at the base station using a selected beam direction of the respective UE devices, wherein the respective UE devices determine the transmission power setting based on their own transmission and reception parameters, on channel characteristics, and on the base station-specific communications performance parameters.

26. The at least one machine-readable medium of claim 25, wherein the base station-specific communications performance parameters are to be transmitted via a plurality of directional beams during a sector sweep operation of the base station.

27. The at least one machine-readable medium of claim 25, wherein the base station-specific communications performance parameters are to be transmitted by the base station via a wide-beam transmission during a receive sector sweep operation of respective UE devices.

28. The at least one machine-readable medium of claim 25, wherein the base station-specific communications performance parameters are to be transmitted by the base station via a wide-beam transmission during a system information broadcast by the base station.

29. The at least one machine-readable medium of claim 25, wherein the base station-specific communications performance parameters are to be transmitted by the base station via base station secondary synchronization signaling (SSS).
